(19) United States
(12) Patent Application Publication
(10) Pub. No.: US 2024/0265438 A1
(43) Pub. Date: Aug. 8, 2024

(54) COMMISSION AGENT BANKING SYSTEM(CABS-AT)

(71) Applicant: AMEHA TEFERA TESSEMA, ADDIS ABABA (ET)

(72) Inventor: AMEHA TEFERA TESSEMA, ADDIS ABABA (ET)

(21) Appl. No.: 18/601,336

(22) Filed: Mar. 11, 2024

Related U.S. Application Data
(60) Provisional application No. 63/617,170, filed on Jan. 3, 2024.

(51) Int. Cl. G06Q 40/02; G06Q 40/03

(52) U.S. Cl. CPC G06Q 40/02; G06Q 40/03

(57) ABSTRACT

A method, system and product program for Commission agent banking system (CABS-AT) to be adopted by bank to be an agent or to be deployed in full-fledge bank to be an agent for investors or depositors' revolving or non-revolving lending money, which can be physical or digital money, through online or offline banking to entrepreneurs/borrowers or on projects already financed by bank having established loan contractual agreement among the fund sellers/investors and fund buyers/entrepreneurs/borrowers and the agent bank (CABS-AT) itself to collect agreed commission on loan price such as interest rate or loan cost rate or profit rate or trade price rate, which can be spot, future spot or forward, calculated on the remaining loan balance, which will be given to investors and pools loan from banks to rehabilitate or sell to investors applying investors or entrepreneurs/borrowers substitution strategy to transfer credit and liquidity risks to new entrant investors and entrepreneurs/borrowers, insurance or to pledged collaterals and in turn managing the liquidity and credit risks transferred from the agent bank (CABS-AT) and sustain the loan repayments collection excess above the agent bank (CABS-AT)′ commission on loan price into investors' real accounts till loan settlement.

### BACKGROUND OF THE INVENTION

The banking sector play important roles in the economy by providing financial services to the society even though the model adopted by bank enforced to collect deposit from the society and provides fund for limited investors. The credit and liquidity risks became long term challenge for banking sector. Because of this banks unable to curve problems of holding non-performing assets or bad debts which ultimately lead them to prone their business. Mobilizing stable deposit to have stable investments in a country became a critical challenge for Islamic and conventional bank. The models adopted by bank unable to escape it from financial crises rather they were a catalyst for financial crises. As a result of this the model adopted by bank forced it to retain rather than transferring liquidity and credit risks to individual investors, non-banking institutions and entrepreneurs/borrowers. So by applying commission agent banking system (CABS-AT), which here after termed as agent bank (CABS-AT), banks can transfer liquidity and credit risks to individual investors, non-banking industries and entrepreneurs/borrowers that enable to enhance their sustainability and profitability in the market by avoiding their liquidity constraint.

Till this era depositors were unable to get lucrative credit price investing their fund on the entrepreneurs/borrowers' projects. Even though conventional and Islamic banks collect a large amount of deposit from the society they disburse it to few wealthy borrowers in the society and because of this fact the model adopted by bank do have little contribution to GDP of the country. There had no possibility by conversional and Islamic banks to finance investors' fund on entrepreneurs' projects exercising agent power for investors to benefit them loan interest rate or loan cost rate or profit rate or trade price rate having collected commission thereon. Since the purpose of the agent bank (CABS-AT) is production of investors and entrepreneurs which can result in production of goods and services to the extent of consumption level of the society, applying commission agent banking system (CABS-AT) chronic problems of a country such as poverty and inflation, which have been a great challenge to curve these problems by Islamic and conventional banks, will be managed and the bank's contribution to GDP also increases.

The loan repayment set by conventional and Islamic bank that should not have been taxable is taxable since repayment effected from net income or profit of the entrepreneur/borrower's business. As the result of this fact salaried and business men have been seeing failed to pay the loan repayment effectively because of tax burden. The profit and loss sharing banking system adopted by Islamic bank is unsuccessful and doesn't guardant the recoup of disbursed loan to investors since the repayment considers from the individual business net profit, which can be affected by internal and external factors that can expense the business or individual borrower unexpected high amount by which the profit can be turned to loss and the system doesn't work for non-profit organization. However this problem can be alleviated by applying commission agent banking system (CABS-AT) which considers repayment as non-taxable since loan is not considered as an income of entrepreneur/borrower and calculated as uneven progressive repayments, which can increase from small to bigger and bigger according to performance of the business having considered the risk, inflation and sensitivity rate, or equal loan repayments which can be held as action plan for given loan period to collect the principal loan amount and loan price, which would be effected in real time as expense of the entrepreneur's business. This practice of the agent bank (CABS-AT) enable to have unwavering loan repayment to investors which had been staying as a great challenge for Islamic and conventional banks.

Conventional and Islamic bank do not have strategies of interchanging borrowers when they deemed failing to continue the loan transaction. Because of this banks are forced to hold large amount of non-performing asset or bad debt which retards the country economy. However adopting the agent bank (CABS-AT) can eradicate liquidity and credit risks which have been a chronic problem for conventional and Islamic banks by applying its investor and entrepreneur substitution strategy so as to manage liquidity and credit risks and sustain the repayments collection to investor till loan settlement.

Securities in capital market like asset back securities have deficiency of resisting the financial crises like that has happened in USA in 2007/08. Furthermore they were the conceiver of this financial crises even though such problems related with securitization has resolved by commission agent banking system (CABS-AT) applying investors and entrepreneurs substitution strategies and by managing risks of investors and entrepreneurs involved in loan transaction. So far conventional and Islamic banks have no outlets to transfer 100% of their liquidity and credit risks to individual investors, entrepreneurs and non-banking institutions because of this fact they forced to retain credit and liquidity risks which ultimately leads them to collapse. The loan disbursement and settlement process of Islamic bank has no clear venue by which the bank has got a tackle in adopting and working with the model plainly and there is no secondary market for Islamic bank because of profit and loss sharing sharia principles. However the above cited problems can be eradicated by applying commission agent banking system (CABS-AT) which is a system to be adopted by bank to be an agent for investor loan funding to entrepreneur administering the loan after disbursement, which will not be held as asset in balance sheet to transfer liquidity and credit risks of the bank adopted it by applying investor and entrepreneur's substitution strategies, collecting reasonable commission on interest rate or loan cost rate or profit rate or trade price rate, which can be spot, future spot or forward, calculated on the remaining loan balance of entrepreneurs/borrowers and the repayment excess above the agent bank (CABS-AT) commission repay back or consider for reinvestment on multiple business projects for investors. So the agent bank (CABS-AT) has full potential to transfer Islamic and conventional banks' credit and liquidity risks to investors, entrepreneurs and non-banking institution by pooling loans and removing the asset from their balance sheet using pooled investors' fund and by rehabilitation their loan having their agency power to administer their loans using only loan profile without removing the loans from their balance sheet applying one of the three lending strategies in order to have mutual economic benefits for banks and agent bank (CABS-AT) by collecting commission on loan price when repayments effected to banks from entrepreneurs/borrowers' accounts.

Agent bank (CABS-AT) is a new banking model which can be applied independently or on both Islamic and conventional banks to refill their gaps and make them profitable and sustainable in the market since it administers interest and non-interest bearing investors' loans. The agent bank (CABS-AT) incubates investors and entrepreneur and till the deposit incubated reaches loanable fund, by which the depositors become an investors using agent bank (CABS-AT) to finance their fund to entrepreneurs/borrowers' projects, the deposit attracts discrete market deposit interest or dividend incentive which can progress according to the growth of deposited money. This can be done by the bank adopted the agent bank (CABS-AT) to utilize the deposit under incubation for loan and later allowing the depositors to finance their deposits on new or already financed project by banks in order to benefit the depositors a credit price such as loan interest rate or loan cost rate or profit rate or trade price rate rather than deposit interest rate immediately up on the portion of fund financed by depositors became under the agent bank (CABS-AT) administration. Whereas independent full-fledged commission agent banking system (CABS-AT) doesn't pay either dividend or interest on incubating deposited amount but loanable deposits could be financed on multiple business projects of entrepreneurs/borrowers to benefit fund holders/depositors/investors loan price such as loan interest rate or loan cost rate or profit rate or trade price rate since the deposit cannot be utilized for its own purpose like conventional and Islamic banks which collects lucrative profit from the deposit. So the model enable the bank to mobilize stable deposit by attracting funds from informal and formal economy. Conventional and Islamic banks do not have recycling benefit from loan repayments by disbursing again to another entrepreneurs/borrowers having transferred credit and liquidity risks in order to collect lucrative and sustainable loan price. However, according to agreement between investors and the agent bank (CABS-AT), the repaid loan amount from entrepreneurs/borrowers can be considered as loan to disburse it again to another entrepreneurs/borrowers in order to benefit loan price to investors.

While the investors' repaid loan amount disbursed to entrepreneurs/borrowers, the agent bank (CABS-AT) calculates either loan interest rate or loan cost rate or profit rate or trade price rate on the remaining unpaid balance on daily bases to benefit the agent bank (CABS-AT) commission on loan interest rate or loan cost rate or profit rate or trade price rate that can be given to investors when repayments effected from multiple entrepreneurs/borrowers' projects. Loan interest rate can be calculated based on market rate and vary according to loan terms' structure, such as short term or medium term or long term loan. Loan cost rate can be calculated based on loan size administration intensity disregarding the loan terms structure which shall be determined by the entrepreneur/borrower and the agent bank (CABS-AT) based on repayment capacity of the borrower. Loan cost rate which can be calculated as the ratio of the agent bank (CABS-AT)′ commission and administrative (financial and non-financial) expense to total principal loan can vary based on the loan size structure set by the agent bank (CABS-AT). The agent bank also calculates profit rate having based on the entrepreneurs/borrowers' business project profit before tax since repayments to be collected from entrepreneurs/borrowers are non-taxable. The agent bank (CABS-AT) set trade price rate, which can be spot or future spot or forward, on one time transaction which can be carried out by the borrower and the supplier of goods. Trade price can be set based on the value of money in the market or the relative value of money in the market. So to do this the agent bank (CABS-AT) shall confirms the investors interests as to whether their fund shall be invested in selected loan interest rate or loan cost rate or profit rate or trade price rate, which can be calculated on interest bearing or non-interest bearing investors' loan, whose loan structure can be short term or medium term or long term loan according to loan repayment capacity of the entrepreneurs/borrowers, Since loan price vary according to loan terms and size of loan. Unless agreement established between the agent bank (CABS-AT) and investors to lend again the repaid loan repayments, that included portion of the principal loan and credit price such as loan interest rate or loan cost rate or profit rate or trade price rate, the loan price which is excess above the commission of the agent bank (CABS-AT) can be credited into investors accounts on agreed periodic bases.

The agent bank (CABS-AT) can minimize the wide gap between informal and formal economy, which had been stayed a big challenge specially for developing countries, since it enable to attract entrepreneurs/borrowers and investors from informal into formal economy. The model enable the bank to collect stable interest rate or loan cost rate or profit rate or trade price rate commission up to loan settlement rather than paying cost of fund to collect interest rate margin having borne credit and liquidity risks.

### SUMMARY OF INVENTION

According to an exemplary embodiment of the present invention, a method for commission agent banking system (CABS-AT) wherein a bank to be an agent for investors' revolving or non-revolving lending money strategies, which can be physical or digital money, through online or offline banking to entrepreneurs/borrowers having established loan contractual agreement among the fund seller and buyer and the agent bank (CABS-AT) itself to collect agreed commission on plurality of loan interest rate or profit rate or loan cost rate or trade price rate, which can be spot, future spot or forward rate, that will be given to one or more investors and for providing alternative investment solution for depositors by allowing them to shift to investor position after establishing agreement with bank to get interest rate or profit rate or loan cost rate or trade price rate on the fund already invested by the bank and the agent bank (CABS-AT) gets commission on interest rate or profit rate or loan cost rate or trade price rate to administer the fund up to loan settlement instead of paying deposit price that will be periodically transferred into plurality of investors accounts, comprising: (a) maintaining or have maintained an electronic database for loan transaction run under commission agent banking system (CABS-AT) in data storage held in CABS-AT central account or operating account for each loan transactions held under investors, entrepreneurs/borrowers and the agent bank (CABS-AT) applying one of the three lending strategies of the agent bank (CABS-AT) to benefit investors loan interest rate or profit rate or loan cost rate or trade price after the agent bank (CABS-AT) has collected commission while pooling loan repayments from plurality of entrepreneurs/borrowers' accounts into plurality of investors' accounts or reinvested loan repayments collected from plurality of entrepreneurs/borrowers accounts to benefit sustainable loan price to investors after the agent bank (CABS-AT) has collected its commission thereon while repayment recouped from entrepreneurs/borrowers; (b) monitoring the agent bank (CABS-AT)'s central account or operating account by which loan transaction carried out by pooling funds from plurality of investors' accounts to invent on plurality of entrepreneurs/borrowers' projects whose accounts maintained at agent bank (CABS-AT) through online, using internet, using computer, webpage, mobile banking and offline mobile banking using agent bank (CABS-AT)'s application or USSD code that connected with serverless computing and server, comprising: the loan transaction to be managed on off-balance sheet loans ledgers integrated with real accounts opened in the name of each investor and entrepreneur/borrower in order to manage loan interest rate or loan cost rate or profit rate or trade price rate applied on each respective remaining loan balances maintained at each off balance sheet loan ledgers to pass decision on crediting loan price along with portion of principal loan into plurality of investors' accounts or reinvent loan repayments per agreement between the agent bank (CABS-AT) and one or more investors; (C) determining or having determined the eligibility of investors fund to be financed on feasible entrepreneurs/borrowers projects through CABS-AT's central account maintained at agent bank (CABS-AT) having applied one of the tree lending strategies of it; (d) reinvesting loan repayments, for one or more investors' loan repayment collected from plurality of entrepreneurs/borrowers' accounts according to their investment seniority calculated by the agent bank (CABS-AT), wherein the loan repayments reinvestment, comprises: the portion of principal loan and/or loan interest rate or loan cost rate or profit rate or trade price rate calculated on remaining loan balance which continuously capitalized on the remaining loan balance of investors and reinvested on the respective entrepreneurs/borrowers' projects after the agent bank (CABS-AT) has collected commission on loan interest rate or loan cost rate or profit rate or trade price rate to transfer into balance sheet income account run under the agent bank (CABS-AT)'s central account or operating account; (c) accessing, incubated depositors fund held at the agent bank (CABS-AT) till the deposited fund of each depositors reaches loanable fund at which the agent bank (CABS-AT) establish agreement with depositors without having them deposit interest rate or dividend to finance the fund on plurality of entrepreneurs/borrowers' projects in order to benefit depositors/investors loan interest rate or loan cost rate or profit rate or trade price rate and the loan transaction of which maintained through CABS-AT's central account or operating accounts; (f) distributing or having distributed the loan repayments collected from plurality of entrepreneurs/borrowers' accounts into plurality of investors' accounts through agent bank (CABS-AT)'s central account or operating account whether the loan transaction run under one of the three lending strategies of the agent bank (CABS-AT).

In further embodiment, monitoring CABS-AT's central account or operating account when each and every loan transaction run by plurality of investors and entrepreneurs/borrowers. In further embodiment, determining eligibility of investors fund and entrepreneurs/borrowers' feasible projects determines steps to set investors and entrepreneurs/borrowers' eligibility criterion.

In further embodiment, reinvestment of loans repayments collected from entrepreneurs/borrowers' accounts determines step to calculate reinvestment amount on behalf of investors according to their investment seniority and every information on specific loan transaction gives special access right code to every parties involved in loan transaction independently.

In further embodiment, a system is provided for commission agent banking system (CABS-AT) to administer loan financed from plurality of investors' accounts into plurality of entrepreneurs/borrowers' real accounts integrated with off balance sheet loan ledgers maintained in name of one or more investors and entrepreneurs/borrowers, comprising: electronic database held in data storage in agent bank (CABS-AT)'s central account or operating account at agent bank (CABS-AT) having each investors, entrepreneurs/borrowers and agent bank (CABS-AT)'s loan transaction, comprising: the loan repayment set for entrepreneurs/borrowers and for new entrant entrepreneurs/borrowers, the selected lending strategy, and the loan price such as loan interest rate or profit rate or loan cost rate or trade price rate that calculated on the remaining loan balance held in CABS-AT's central account or operating account, loan repayments reinvestment transactions held under plurality of investors and entrepreneurs/borrowers loan ledgers integrated with the respective real accounts maintained in name of investors and entrepreneurs/borrowers, plurality of depositors funds under incubation wherein loanable fund financed by the agent bank (CABS-AT) on plurality of entrepreneurs/borrowers accounts and the agent bank (CABS-AT) commission on investor's loan price and maintained in CABS-AT's central account or operating account; and one or more processers operably connected to database for implementing the following components: (a) a components for monitoring control account held at the agent bank (CABS-AT) to administer the loan after disbursement from plurality of investors' accounts into respective entrepreneurs/borrowers' projects through related account opened in the name of entrepreneurs/borrowers and to administer loan repayment reinvestment and deposit incubation held for financing entrepreneurs/borrowers projects whose balance maintained at control account of the agent bank (CABS-AT); (b) a components to calculate portion of principal loan repayments collected on behalf of investors, to calculate the investors' loan repayment collected reinvestment amount according their investment seniority, to calculate loan interest rate or Loan cost rate or profit rate and to calculate investors' benefit on trade transactions held in CABS-AT′ central account or control operating account; (c) a components for investing investors' fund in multiple entrepreneurs/borrowers projects under multiple loan interest rate or loan cost rate or profit rate or trade price rate in different loan terms such as short term or medium term or long terms loan held in CABS-AT′ central account or control operating account; (d) a components for reinvesting portion of principal loan and/or loan price such as loan interest rate or loan cost rate or profit rate or trade price rate on behalf of the investors by agent bank (CABS-AT) and collecting the agent bank (CABS-AT)'s commission on each and every loan interest rate or profit rate or loan cost rate or trade price rate into balance sheet income account held in CABS-AT′ central account or control operating account; (e) a components for pooling funds from plurality of investors' accounts into entrepreneurs/borrowers' accounts to hold the loan transaction on off balance sheet loan ledgers created in name of respective investors and entrepreneurs/borrowers to transfer liquidity and credit risks to investors and entrepreneurs/borrowers and in turn manage risks of parties involved in loan transaction held in CABS-AT′ central account or control operating account.

In a further embodiment, a program product is provided for commission agent banking system (CABS-AT) to handle loan rehabilitation by pooling loans from plurality of banks based on profile of the loan originating borrowers without removing the asset from loan originating balance sheet through agent bank (CABS-AT)'s central account or control operating account applying borrowers by entrepreneurs substitution strategies; comprising: one or more computer usable media having computer or mobile banking readable program embodied therein or among them, to be executed by a computer or mobile banking, the computer or mobile banking readable program code comprising: (a) program code for maintain or having maintained an electronic database held in data storage in agent bank (CABS-AT)′ central account or control operating account to pool loans from plurality of banks and rehabilitate loans on behalf of banks having only profile of the debtors without removing the assets from respective banks' balance sheet to recoup loan repayment excess above the agent bank (CABS-AT)'s commission on loan interest rate or loan cost rate or profit rate or trade price rate from plurality of borrowers' accounts that be given to loan originated banks having applied borrowers' substitution strategies and for maintaining each and every loan transaction maintained on behalf of loan originated banks held through agent bank (CABS-AT)'s central account or control operating account; (b) program code for monitoring the loan transaction in agent(CABS-AT)'s central account handled or control operating account to pool loan repayments from plurality of borrowers' accounts into plurality of banks' accounts maintained at agent bank (CABS-AT) and monitoring each loan transaction data information available on off balance sheet loan ledger integrated with real account of the bank as well as the borrowers that could be accessible by the parties involved in the loan transactions; (C) program code for determining or having determined one or more loans pooled from plurality of banks to administer loan without removing from their respective banks' balance sheets and to determine if the loan status determined as the borrowers deemed failing to pay loan repayments to loan originated bank, applying borrower's substituting strategy of the agent bank (CABS-AT) by entrepreneurs, to have sustainable loan repayments excess above the agent bank (CABS-AT) commission on interest rate or loan cost rate or profit rate and trade price rate from plurality of borrowers' accounts into plurality of loan originated banks; (d) program code for changing or having changed loan repayment attribution because of application of borrowers' substitution strategies to pool loan repayments from respective new entrant entrepreneurs and credit excess above the agent bank (CABS-AT)'s commission on loan interest rate or loan cost rate or loan profit rate or trade price rate into respective plurality of loan originated banks' accounts maintained in agent bank (CABS-AT)'s central account or control operating account; (c) program code for pooling loan repayments from plurality of borrowers' accounts to credit into plurality of loan originated banks, wherein the loan repayments are excess above the agent bank (CABS-AT) commission on loan interest rate or loan cost rate or profit rate or trade price rate and the transaction of which handles in agent bank (CABS-AT)'s central account or control operating account; (f) program code for generating instructions for loan repayments collection, reporting, communicating and managing risks on loan transaction which is accessible by the loan originated banks, borrowers and the agent bank itself in Agent bank (CABS-AT)'s central account or control operating account.

In further embodiment, program code is provided for commission agent banking system (CABS-AT) to pool loans from plurality of banks by removing the pooled loans from balance sheet of respective loan originated banks by fund pooled from plurality of investors' accounts having established loan contractual agreement or issue securities for investors having applied investors and entrepreneurs' substitution strategies and investors' loan repayment reinvestment per agreement between the agent bank (CABS-AT) with interested investors to benefit investors loan interest rate or loan cost rate or profit rate or trade price rate after the agent bank (CABS-AT) has collected its commission and the loan transaction run through CABS-AT's central account or control operating account, comprising: one or more computer or mobile banking usable media having computer or mobile banking readable program embodied therein or among them, to be executed by a computer or mobile banking, the computer or mobile banking readable program code comprising: (a) program code for monitoring agent bank (CABS-AT)'s central account or control operating account while pooling loans from plurality of banks and removing the asset from respective balance sheet by pooled investors' fund and administrating the loan transaction through off balance sheet loan ledgers opened in the name of each investors and entrepreneurs/borrowers and managing information of each loan transaction data on pooled loans till settlement to benefit investors loan interest rate or loan cost rate or profit rate or trade price rate after the agent bank (CABS-AT)'s commission calculated credited into the agent bank (CABS-AT) balance sheet income account due to loan repayments recouped from plurality of borrowers/entrepreneurs' accounts into plurality of investors' accounts through the agent bank (CABS-AT)'s central account or control operating account; (b) program code for reinvesting loan repayments collected from plurality of entrepreneurs/borrowers' accounts into plurality of investors' accounts through agent bank (CABS-AT)'s central account or control operating account based on established agreement between investors and agent bank (CABS-AT) and applying one of the three lending strategies of agent bank (CABS-AT) in order to benefit investors sustainable loan interest rate or loan cost rate or profit rate or trade price rate after the agent bank (CABS-AT) has collected commission thereon to transfer into its balance sheet income account through agent bank (CABS-AT)'s central account or control operating account; (c) program code for changing or having changed loan repayments attribution because of investors and entrepreneurs/borrowers substitution strategies in one or more electronic database held in data storage in agent bank (CABS-AT)'s central account or control operating account; (d) program code for collecting loan repayment from plurality of entrepreneurs/borrowers' accounts and transfer into plurality of investors' accounts after collecting the agent bank (CABS-AT)'s commission on loan interest rate or loan cost rate or profit rate or trade price rate and manage the remaining loan balance on off balance sheet loan ledgers opened independently in name of each investors and entrepreneurs/borrowers; (c) program code for generating instructions on loan transaction such as on each loan disbursements from plurality of investors' accounts and to have transferred loan repayments from plurality of entrepreneurs/borrowers accounts into investors' accounts which can be carried out through the agent bank (CABS-AT)′ central account or control operating accounts; (f) program code for generating each loan transaction report, communication and managing risk of each loan transaction carried out through agent bank (CABS-AT)'s central account or control operating account.

In yet further embodiment, a program product is provided for commission agent banking system (CABS-AT) to run international and/or local loan transaction by pooling funds from international/local investors/fund sellers' accounts and invest in entrepreneurs/borrowers business projects where the fund seller and buyer can be found at district or within the country and the loan admiration runs by agent bank (CABS-AT) at any or within the country holding the loan transaction through agent bank (CABS-AT)′ central account or control operating account applying one of the three lending strategies of the agent bank (CABS-AT), wherein the loan transaction can be carried out on off balance sheet loan ledgers opened independently integrated with real accounts of respective investors and entrepreneurs/borrowers integrated with financed business project so as to agile the loan transaction including loan price manipulation to benefit investors loan interest rate or loan cost rate or profit rate or trade price rate after the agent bank has collected commission thereon while one or more loan repayments effected from plurality of entrepreneurs/borrowers' accounts into plurality of investors' accounts, comprising: one or more computer usable media having computer and mobile banking readable program embodied therein or among them, to be executed by a computer or mobile banking, the computer or mobile banking readable program code comprising: (a) program code for monitoring agent bank (CABS-AT)'s central account or control operating account during loan interim period through which the agent bank (CABS-AT) pools loans from plurality of investors' accounts after screening the eligibility and approval of investors source of fund and feasibility of entrepreneurs/borrowers business project to invest on plurality of entrepreneurs/borrowers' business projects and the loan transaction carried out through off balance sheet loan ledgers integrated with real accounts in name of respective investors and entrepreneurs/borrowers independently opened in the agent bank (CABS-AT)'s control operating account; (b) program code for reinvestment of loan repayments recouped from plurality of entrepreneurs/borrowers' accounts into plurality of investors' accounts to reinvest the loan repayments collected in multiple business projects of entrepreneurs/borrowers so as to benefit investors loan interest rate or loan cost rate or profit rate or trade price rate after the agent bank (CABS-AT) has collected commission thereon into balance sheet income account maintained in agent bank (CABS-AT)'s central account or control operating account; (c) program code for determining or have determined the disbursed loan status maintained in agent bank (CABS-AT) central account or control operating account while the entrepreneurs/borrowers deemed failing to pay the debt so as to take measure of entrepreneurs/borrowers substitution strategies having considered also investors substitution strategies of the agent bank (CABS-AT); (d) program code for changing or have changed loan repayments attribution because of investors and entrepreneurs/borrowers substitution strategies to manage the loan repayments collection from plurality of new entrant entrepreneurs/borrowers' accounts into plurality of new entrant investors' accounts and the loan transaction of which can be run through agent bank (CABS-AT) central account or control operating account; (c) program code for generating instruction to disburse loan from plurality of investors' accounts to plurality of entrepreneurs/borrowers' projects and to pool repayments from plurality of entrepreneurs/borrowers' accounts and credit the repayments excess above the agent bank (CABS-AT) commission on loan interest rate or loan cost rate or profit rate or trade price rate calculated on the remaining loan balance of entrepreneurs/borrowers and credit into plurality of investors' accounts and the loan transaction of which can be run through agent bank (CABS-AT) central account or control operating account; (f) program code for investors and entrepreneurs/borrowers substitution strategies to manage liquidity and credit risks by transferring to new entrant investors and entrepreneurs/borrowers to in turn manage credit and liquidity risks of parties involved in loan transaction which can be run through agent bank (CABS-AT) central account or control operating account; (g) program code for accessing incubated investors and entrepreneurs' fund held at agent bank (CABS-AT) as deposit accounts without having deposit interest rate or dividend till they reach loanable fund where the agent bank (CABS-AT) invest them in multiple entrepreneurs/borrowers' business projects so as to benefit investors/depositors loan interest rate or loan cost rate or profit rate or trade price rate after the agent bank (CABS-AT) has collected commission thereon into its balance sheet income account and the loan transaction of which can be run through agent bank (CABS-AT) central account or control operating account.

### BRIEF DESCRIPTION OF THE DRAWINGS

Details of various exemplary embodiments of this invention will be described, with reference to the following figures, wherein:

FIG. 1: is a flowchart of a system for managing revolving and non-revolving lending strategies of commission agent banking system (CABS-AT) to exemplary embodiment of the present invention;

FIG. 2: is a flowchart of a system for managing money depositors lending strategy of commission agent banking system (CABS-AT) to exemplary embodiment of the present invention;

FIG. 3: is a flowchart of a system for managing pooled loans from banks for administration under commission agent banking system (CABS-AT) to exemplary embodiment of the present invention;

FIG. 4: is a flow chart illustrating accounting entries management of loan transaction on project xxx integrated with respective investors and entrepreneurs/borrowers' real accounts integrated with off balance sheet loan ledgers to exemplary embodiment of the present invention;

FIG. 5: is a block diagram of a system for managing online and offline banking loan transaction between investors and entrepreneurs/borrowers under commission agent banking system (CABS-AT) to exemplary embodiment of the present invention;

FIG. 5A: is a flowcharts illustrating online and offline banking loan transaction steps for investors and entrepreneurs/borrowers under commission agent banking system (CABS-AT) to exemplary embodiment of the present invention;

FIG. 6: is a block diagram of a system for commission agent banking system (CABS-AT)'s credit and liquidity risks transferring mechanism to exemplary embodiment of the present invention;

FIG. 7: is a flowchart of system for managing international or national loan transaction accounts under commission agent banking system (CABS-AT) to exemplary embodiment of the present invention;

FIG. 8: is a flowchart illustrating loan interest rate or loan cost rate or profit rate or trade price rate or other commission of investors and the commission agent banking system (CABS-AT)′ commission to exemplary embodiment of the present invention;

FIG. 9: is a flowchart of a system for loan repayments reinvestment administration under commission agent banking system (CABS-AT) to exemplary embodiment of the present invention.

### DETAILED DESCRIPTION OF THE INVENTION

The following terms are used with indicated meaning:

“Real account” comprises loan transaction account in which individual or entity investors' or incubating deposits maintain and loan disbursement effect to individual or entity entrepreneurs/borrowers and by which individual or entity investors receive loan repayments from individual or entity entrepreneurs/borrowers and by which individual or entity entrepreneurs/borrowers receives loan amount from individual or entity investors and from which individual or entity entrepreneurs/borrowers pay loan repayments to individual or entity investors.

Off balance sheet loan ledger comprises loan disbursement from individual or entity investors and to individual or entity entrepreneurs/borrowers independently and loan interest rate or loan cost rate or profit rate or trade price rate can be calculated in separate column to clearly show principal loan and loan price flow from investors to entrepreneurs/borrowers.

Loan repayment reinvestment comprises portion of principal loan repayments and/or loan price of investors can be invested on entrepreneurs/borrowers business projects again and again per agreement between investors and agent bank (CABS-AT).

Incubating deposit comprises multiple depositors' deposit maintain in name of individuals and entities without deposit interest rate or dividend to pool loanable fund from these accounts and invest on entrepreneurs/borrowers business projects to benefit depositors/investors loan interest rate or loan cost rate or profit rate or trade price rate.

“Digital lending” comprises loan transaction such as pooling loan from investors' accounts or incubating deposit accounts and invest on entrepreneurs/borrowers' accounts and manage the principal loan disbursed and loan price collection electronically.

“Digital money” or “physical money” comprises acceptable electronic or physical medium of exchange in the form of coins or banknote and holder of it has the right vested by government to invest on entrepreneurs/borrowers business projects.

“Commission rate” comprises agent bank (CABS-AT) commission rate set by agent bank (CABS-AT), which calculates on investors' loan price such as loan interest rate or loan cost rate or profit rate or trade price rate, which can be calculated on investors' disbursed loan and collected from entrepreneur/borrowers' projects where the investors' fund invested.

The present invention relates, in one embodiment, to system and method for Commission agent banking system (CABS-AT) which is to be adopted by bank to be an agent for plurality of investors' revolving or non-revolving lending money, which can be physical or digital money, through online or offline banking to plurality of entrepreneurs/borrowers having established loan contractual agreement among the fund sellers/investors and buyers/entrepreneurs/borrowers and the agent bank (CABS-AT) itself to collect agreed commission on loan interest rate or loan cost rate or profit rate or trade price rate which can be calculated on the remaining loan balance of entrepreneurs/borrowers that will be given to investors and pools loan from banks to rehabilitate or sell to investors applying investors or entrepreneurs/borrowers substitution strategy to transfer credit and liquidity risks to new entrant investors and entrepreneurs/borrowers, loan default insurance or to pledged collaterals and in turn managing the liquidity and credit risks transferred from the agent bank (CABS-AT) and sustain the loan repayments collection excess above the agent bank (CABS-AT)′ commission on loan price into investors' real accounts till loan settlement.

In further embodiment, the invention relates to system and method to adopt commission agent banking system (CABS-AT) the following tree-truck lending strategies obliged to be implemented
1. Revolving lending strategy: The parties involved in this lending strategy are investors, entrepreneurs/borrowers and the agent bank (CABS-AT). Here the lending system focus on many fund sellers to one fund buyer, or one fund seller to many fund buyers or one fund seller to one fund buyer where loan repayments reinvestment allowed for investors. The investor select the entrepreneur's project either from market or from commission agent bank system (CABS-AT) to lend money to entrepreneurs/borrowers either with collateral where there is no prior partnership established between the fund sellers and buyers or without collateral where there is prior partnership established between the fund sellers and buyers. The investors lend money to entrepreneurs/borrowers without collateral where prior partnership established and later when loan repayments collected reinvested on another entrepreneurs/borrowers projects where collateral pledging required by entrepreneurs/borrowers. Reinvestment of loan repayments can be carried out according to investors investment seniority in multiple entrepreneurs/borrowers projects by agent bank (CABS-AT) based on the investors' agreement in loan contractual agreement either including or non-including the loan price calculated on specific selected loan term such as short term or medium term or long term loan or loan amount since each of which loan term interest rate or loan cost rate or profit rate or trade price rate vary accordingly and the loan of investors disbursed on multiple projects administer by agent bank (CABS-AT) by creating link between one or more investors real accounts integrated with fund ledgers with one or more entrepreneurs/borrowers' real accounts integrated with loan ledgers on off balance sheet directly to pay the remaining portion of disbursed fund balance of investors and remaining loan balance of entrepreneurs/borrowers. The agent bank calculates loan interest rate or loan cost rate or profit rate or trade price rate daily on investors or entrepreneurs loan ledgers' balance and set in separate column without capitalizing on principal balance. So the investor benefits sustainable loan interest rate or loan cost rate or profit rate or trade price rate after the agent bank (CABS-AT) has collected its sustainable commission on interest rate or loan cost rate or profit rate or trade price rate calculated on respective remaining loan balance. This lending strategy enable the investors to invest in multiple projects of entrepreneurs/borrowers while prior projects' loan settled in their due dates. Should investor wishes to withdraw the loan transaction the agent bank (CABS-AT) sell the remaining principal loan balance to another interested investor. Should entrepreneur fail to pay the loan the entrepreneur full-fledge business rents to selected entrepreneur using own working capital considering the business income excess above the loan repayments as profit of new entrant entrepreneur without property ownership transfer unless otherwise loan disbursed unpaid. If entrepreneur's project selected by agent bank (CABS-AT) on behalf of the investors based on investment interest on a project, Agent bank (CABS-AT) charges investors onetime fec.
2. Non-revolving lending strategy: The parties involved in this lending strategy are investors, entrepreneurs and the agent bank (CABS-AT) itself. Here the lending system focus on many fund sellers to one fund buyer, or one fund seller to many fund buyers or one fund seller to one fund buyer where loan repayment reinvestment doesn't allowed by investors. The investor selects the entrepreneur project either from market or from commission agent bank system (CABS-AT) to lend money to entrepreneur/borrower either with collateral where there is no prior partnership established between the fund seller and buyer or without collateral where there is prior partnership established between the fund seller and buyer. One or more investors lend money to one or more entrepreneurs without establishing agreement with the agent bank (CABS-AT-AT) to reinvest the repayments collected from one or more entrepreneurs/borrowers and the repayment, which contain the principal loan and loan price, excess above the agent bank (CABS-AT)′ commission periodically credited into one or more investors' specific or general real accounts. The loan after disbursement administer by agent bank (CABS-AT) by creating link investors disbursement fund real accounts integrated with disbursement loan ledgers with entrepreneurs' real accounts integrated with loan ledgers on off balance sheet where the fund invested to recoup repayment and pay the fund balance periodically through established real accounts of investors and entrepreneurs/borrowers and to calculate loan interest rate or loan cost rate or profit rate or trade price rate after the agent bank (CABS-AT)'s commission has collected, on the remaining principal balance of investor and entrepreneur on off balance sheet without capitalizing on the principal balance to credit investors' accounts periodically the portion of principal loan repayments and the loan price excess above the agent bank (CABS-AT)′ commission. Should the investor wish to withdraw the loan transaction the agent bank (CABS-AT) sells the remaining uncollected loan balance to another interested investor. Should entrepreneur fail to pay the loan repayment the agent bank (CABS-AT) rents the entrepreneur's full-fledge business to new entrant entrepreneur with own working capital to benefit the new entrant entrepreneur the business profit excess above the loan repayments. If entrepreneur's project selected by agent bank (CABS-AT) on behalf of the one or more investors based on investment interest on a project, agent bank (CABS-AT) charges the investors onetime fec.
3. Money depositors lending strategy: The parties involved in this lending strategy are money depositors and the bank where the money deposited. The depositors can have preference either to have loan share on the project already invested by bank or on new project to get loan interest rate or loan cost rate or profit rate or trade price rate instead of getting from bank saving interest rate or dividend after the agent bank (CABS-AT) has collected agreed commission thereon to administer the portion of loan share till settlement. Per established agreement between the investor/depositor and the agent bank (CABS-AT) this lending strategy adopts either revolving or non-revolving lending strategy based on the agreed loan term, such as short term or medium or long term loan or loan amount selected by investor/depositor. To calculate either loan interest rate or loan cost rate or profit rate or trade price rate on the remaining investors/depositors and entrepreneur/borrowers' loan balance on off balance sheet, the investors/depositors loan ledgers integrated with real accounts have to be linked with entrepreneurs/borrowers' project loan ledgers integrated with real accounts where the respective investors fund invested. Should the investor wish to discontinue the loan transaction the agent bank sell the remaining principal uncollected loan to new entrant investor through agent bank (CABS-AT). Should the entrepreneur fail to pay the loan the entrepreneur's full-fledge business rents to new entrant entrepreneur with own fund without property ownership transfer unless otherwise the disbursed loan unable to be recouped. So the investors collect sustainable loan interest rate or profit rate or loan cost rate or trade price rate after the agent bank (CABS-AT) has collected sustainable commission thereon. If entrepreneur's project selected by agent bank (CABS-AT) on behalf of the investors based on investment interest on a project, agent bank (CABS-AT) charges the investors onetime fec.

In further embodiment, the three lending strategies of agent bank (CABS-AT) enable the agent bank (CABS-AT) to transfer credit and liquidity risks to investors and entrepreneurs/borrowers to produce multiple investors and entrepreneurs in the society and to improve the investment and thereby contributing towards GDP applying investors and entrepreneurs' substitution strategies. In further embodiment, the transferred liquidity and credit risks to investors and entrepreneurs/borrowers manage by the agent bank (CABS-AT) with the support of cutting edge risk predicting professionals and technologies and business consulting service in order to establish mutual benefit among investors, entrepreneurs/borrowers and the agent bank (CABS-AT).

In further embodiment, the agent bank (CABS-AT) pools fund from plurality of investors' accounts and invest on plurality of entrepreneurs/borrowers' business projects through accounts maintained at agent bank (CABS-AT) and administers the loan after disbursement applying one of the three lending strategies in order to benefit investors loan interest rate or loan cost rate or profit rate or trade price rate which calculates on the remaining loan balance maintain at off balance sheet loan ledgers integrated with real accounts of investors linked with off balance sheet loan ledgers integrated with real accounts of entrepreneurs/borrowers after the agent bank (CABS-AT) has collected commission on loan interest rate or loan cost rate or profit rate or trade price rate while loan repayments effected from one or more entrepreneurs/borrowers' accounts into one or more investors' accounts. In further embodiment, when investors or entrepreneurs/borrowers fail to continue the loan transaction the agent bank (CABS-AT) applies investors or entrepreneurs/borrowers substitution strategy in order to sustain the loan repayments collection till loan settlement.

In further embodiment, the early withdrawal of investors is handled by an agent bank by selling the remaining uncollected principal loan balance to new entrant investor interested in the project to maintain the disbursed loan collection until loan settlement by levy onetime fee on withdrawing investors. The agent bank (CABS-AT)'s loan selling process must be confidential between the investor and agent bank (CABS-AT), but after the loan has been sold, the agent bank (CABS-AT) informs investors' investment related entrepreneurs/borrowers to amend the loan contract without further interest rate or loan cost rate or profit rate or trade price rate and other service price amendment to avoid any moral hazard of the debtor. In further embodiment, while entrepreneurs/borrowers deemed failing to pay the loan to investors, the agent bank (CABS-AT) rents the withdrawing entrepreneurs/borrowers' business project or properties to new entrant entrepreneurs with own working capital without the original borrowers' properties ownership transfer to the third party unless the loan unable to recoup into investors' accounts. In further embodiment, money depositors at conventional and at Islamic banks can move to investor position by buying loan share on project already financed by the banks or new projects to have loan interest rate or profit rate or loan cost rate or trade price rate on portion loan share instead of deposit interest rate or dividend while considering portion of loan share to be administered under the agent bank (CABS-AT) which collects commission on loan interest rate or profit rate or loan cost rate or trade price rate which calculated on loan share of investors.

In further embodiment, the agent bank can incubate depositors fund till it reaches loanable fund, without paying deposit interest rate or dividend on deposited fund, from which the agent bank (CABS-AT) pools fund from plurality of depositors' accounts and invest on plurality of entrepreneurs/borrowers' accounts through established accounts at the agent bank (CABS-AT) applying one of the three lending strategies in order to benefit depositors/investors loan interest rate or loan cost rate or profit rate or trade price rate which calculates on the remaining loan balance of entrepreneurs/borrowers after the agent bank (CABS-AT) has collected its commission on loan interest rate or loan cost rate or profit rate or trade price rate into its balance sheet income account.

In further embodiment, the agent bank (CABS-AT) can handle asset backed by securities in order to refill financial gap of Islamic and conventional banks and get commission income from loan administration. Financial institution like banks can sell selected loans and receivables to agent bank (CABS-AT) which assess the credit enhancement of the loan and receivables to issue securities or contractual agreement later to investors in the market. The loan and receivables should be guaranteed by marketable security by which later it reimburses the investors by selling the security should there is no alternative solution after applying investors and entrepreneurs/borrowers substitution strategies. The agent bank (CABS-AT) establishes contractual agreement between the borrowers whose loan pooled from conventional or Islamic banks to agent bank (CABS-AT) and the would be an investors in the market and the agent bank (CABS-AT) itself to have strong trust among the parties involved in loan transaction and to remove the asset from balance sheet of loan originated bank and administer the loan applying one of three lending strategies.

In further embodiment, commission agent bank (CABS-AT) pools loans from plurality of Conventional and Islamic banks to administer trouble loans of the banks using only profile of debtors without removing the assets from balance sheets of respective banks. This can be done by having precaution agreement between the respective bank and agent bank (CABS-AT) as well as the loan originated borrowers. Here the bank uses agent bank (CABS-AT) as agent to administer the debt of the borrowers by having applied its borrower's substitution strategies till loan settlement and later to return the asset to original borrowers after the loan has settled. The depositors whose fund financed on the project can participate on the project already financed by the bank which latter cease calculation of saving interest rate or dividend up on agreement between the depositors and the bank and the loan share held by depositors became under the admiration of agent bank (CABS-AT) by transferring liquidity and credit risks of the bank to the depositor who then would be an investor to collect loan interest rate or loan cost rate or profit rate or trade price rate on the portion of deposit already invested by the bank after the agent bank (CABS-AT) has collected its commission thereon. In order to settle the loan from loan originated banks' balance sheets the agent bank (CABS-AT) applies one of the three lending strategies.

In further embodiment, Loan repayment considered by agent bank (CABS-AT) not be taxable and be considered as the individual entrepreneurs/borrowers or salaried person's expense and the repayment calculates by agent bank (CABS-AT) can be progressive repayments, which can increase from small to bigger and bigger according to the performance of the entrepreneurs/borrowers' business having considered inflation, risk and sensitivity rate, or fixed loan repayments which include the principal loan and the price of loan ahead of disbursement and make action plan to collect the repayments of the loan having considered as the business/project expense. In order to curve loan repayment variation the agent bank (CABS-AT) aware the entrepreneurs/borrowers to make loan repayment adjustment either by engaging with insurance or from other source of incomes if loan repayment variation met when the entrepreneurs/borrowers repay loan in real time from repayment set in loan contractual agreement.

In further embodiment, Loan transaction of investors and entrepreneurs using commission agent bank (CABS-AT) can be run through online using internet through computer and offline banking using agent bank (CABS-AT)′ application or USSD code. The procedures can be investors and entrepreneurs that wish to involve in loan transaction can apply at Commission agent banking system (CABS-AT)'s website or mobile banking or at agent bank (CABS-AT) branch based on basic feasible requirement of the agent bank (CABS-AT) which analysis the applicants' funding source and credit history of entrepreneurs/borrowers and later to establish tri-party agreement which includes investors, entrepreneurs and the agent bank (CABS-AT) itself applying one of the three lending strategies of agent bank (CABS-AT) where it allow substitution of investors or entrepreneurs by new entrants investors or entrepreneurs without the original entrepreneurs' properties ownership transferring to next party that would be involved in loan transaction. Even though the loan transaction carried out online using one or more computers or mobile banking the agent bank (CABS-AT) manage the business of the entrepreneurs/borrowers to safeguard entrepreneurs/borrowers' business from kinds of risks such as liquidity and credit risks. Investors and entrepreneurs involved on same projects' investment grant loan transaction identification code which is also known by agent bank (CABS-AT) which enable to run the disbursement and collection of loan online through one more computers or offline banking, using mobile banking, using parties' identification codes or real account numbers. In further embodiment, through digital banking the agent bank (CABS-AT) can incubate depositors deposit till it reach loanable fund without paying deposit interest rate or dividend on deposited amounts later to invest the fund digitally on plurality of entrepreneurs/borrowers' projects through established respective accounts digitally having applied one of the three lending strategies. In further embodiment, the agent bank (CABS-AT)'s digital banking enable investors to place their fund in accounts opened at agent bank (CABS-AT) which enable to pool the fund from plurality of investors' accounts to invest on plurality of entrepreneurs/borrowers' projects through established accounts at agent bank (CABS-AT). While loan repayments effected by entrepreneurs/borrowers into investors ‘digital real accounts through the agent bank (CABS-AT)'s central account or control operating account, investors collects loan interest rate or profit rate or loan cost rate or trade price rate calculated on the remaining loan balance of entrepreneurs/borrowers and the agent bank (CABS-AT) collects commission thereon to credit into its balance sheet income account maintained in the agent bank (CABS-AT)'s central account or control operating account.

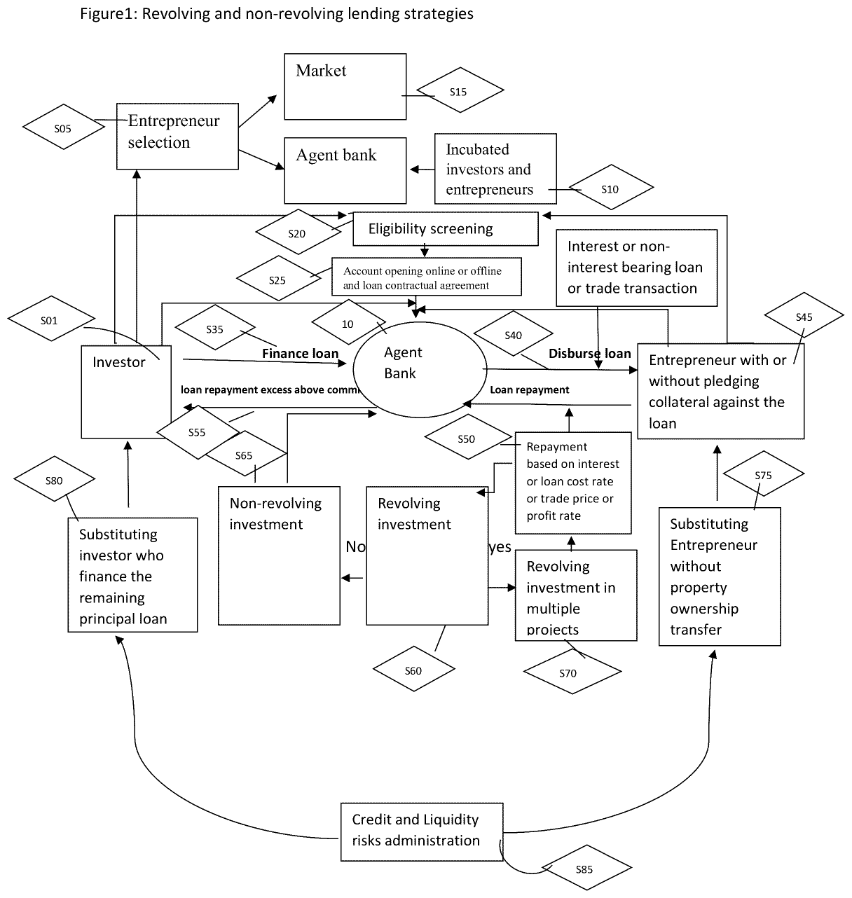

FIG. 1: Depicts the revolving and non-revolving lending strategies of agent bank (CABS-AT), by which the bank adopted the agent bank (CABS-AT) 10 needs to implement, which considered as one embodiment of the present invention. An investor, in step S01, that has an idle fund on hand wishes to invest it through agent bank (CABS-AT) 10 on entrepreneur/borrower project by selecting the project, in step S05, either from the agent bank (CABS-AT) 10 which are under incubation, where an entrepreneurs and investors can be incubated, in step S10, or from the market, in step S15. Investors incubated under agent bank (CABS-AT) 10 till their deposit reach loanable fund can be ready to substitute a withdrawing investor or can be an investor to finance their fun on an entrepreneurs/borrowers' projects. In case the agent bank select an entrepreneur/borrower project for an investor, the agent bank (CABS-AT) 10 charges the investor onetime fec. Once the two parties, investor and entrepreneur/borrower, agree to transact a loan, they presented at agent bank (CABS-AT) 10 and the agent bank starts to make eligibility screening, in step S20, so as to assure where the investor's source of fund is and the entrepreneur/borrower credit credentials are prudent and legitimate to allow the loan transaction. Once the screening process permits investor and entrepreneur/borrower to transact the loan through Agent bank (CABS-AT) 10, in step S20, the agent bank (CABS-AT) 10 establishes tri-party agreement and make the parties involved in loan transaction to open account, in step S25, in their name for loan transaction purpose. So the investor, in step S01, finance loan, in step S35, from the account into the agent bank (CABS-AT)'s 10 central account or the agent bank pools fund of investor into agent bank (CABS-AT)'s 10 central account and disburse loan, which can be interest or non-interest bearing loan or trade transaction, in step S40, to entrepreneur that pledges or not collateral, in step S45, according to agreement between investor and entrepreneur/borrower. Unless the agent bank (CABS-AT) 10 unable to recoup and where there is no alternative options to recoup the loan disbursed from investor to entrepreneur/borrower the collateral pledge by the entrepreneur/borrower publicly auctioned to recoup the remaining unpaid principal loan and loan price and the agent bank (CABS-AT) 10 commission and additional financial and non-financial expense. However, the objective of agent bank (CABS-AT) 10 is production of investor and entrepreneur in the country so as to increase production of goods and services to the society consumption level. So after applying investor and entrepreneur substitution strategy and the loan has settled the pledged collateral against the loan returned to the property owner borrower since selling of pledged collateral is not the prior objective of the agent bank (CABS-AT) 10. In step S50, the entrepreneur/borrower that borrowed loan from investor, in step S01, to run the business starts paying repayment, which has been calculated based on interest rate or loan cost rate or profit rate or trade price, into investor's account through the agent bank (CABS-AT) 10, which collects commission on interest rate or loan cost rate or profit rate or trade price and the excess above which transfers into investor's account, in step S55. In step S60, according to agreement between the investor and the agent bank (CABS-AT) 10 under revolving lending strategy where reinvestment of repayments allowed loan repayment of investor can be reinvested while the agent bank (CABS-AT) 10 takes its commission from loan price. Otherwise, In step S65, should the loan agreement between investor and the agent bank (CABS-AT) 10 is under non-revolving lending strategy where reinvestment of repayment not allowed the agent bank (CABS-AT) 10 transfers portion of principal loan repayment including the loan price excess above the agent bank (CABS-AT)'s commission into investor's account per specific period according to their loan recouping agreement. According step S60, should the agreement between investor and the agent bank (CABS-AT) 10 be under revolving investment where reinvestment of repayments allowed the loan repayments recouped by the agent bank (CABS-AT) 10 reinvested in multiple projects, in step S70, where pledging collateral of the entrepreneurs/borrowers required. Should entrepreneur/borrower likely or deem fail to pay the loan to investor, the agent bank (CABS-AT) 10 substitutes the borrower/entrepreneur without property ownership transfer, by new entrant entrepreneur, in step S75, either from the market, in step S15, or incubated entrepreneur, in step S10. The new entrant entrepreneur undertakes the full-fledged business of the withdrawing entrepreneur/borrower with own working capital in order to recoup later the business profit excess above the loan repayment revised and set by the agent bank (CABS-AT) 10. Should an investor wishes to withdraw the loan transaction, the agent bank (CABS-AT) 10 substitutes the withdrawing investor by new entrant investor, in step S80, selected either from the market, in step S15, or incubated investor, in step S10 that is going to finance the remaining principal loan to withdrawing investor through the agent bank (CABS-AT) which collects onetime fee from withdrawing investor considering it as cost of searching alternative substituting investor. Even though the main purpose of the agent bank (CABS-AT) 10 is transferring credit and liquidity risks from the bank adopted it or itself to investor and entrepreneur/borrower, it manages the transferred credit and liquidity risks, in step S85, in order to maintain mutual benefit among investor, entrepreneur/borrower and the agent bank (CABS-AT) 10 itself. So managing risks of investor and entrepreneur/borrower enable the agent bank (CABS-AT) 10 to manage healthy loan and enable to recoup loan repayments properly up to loan settlement. So in order to manage the transferred credit and liquidity risks to investor and entrepreneur/borrower the agent bank (CABS-AT) 10 apply investor and entrepreneur/borrower substitution strategy.

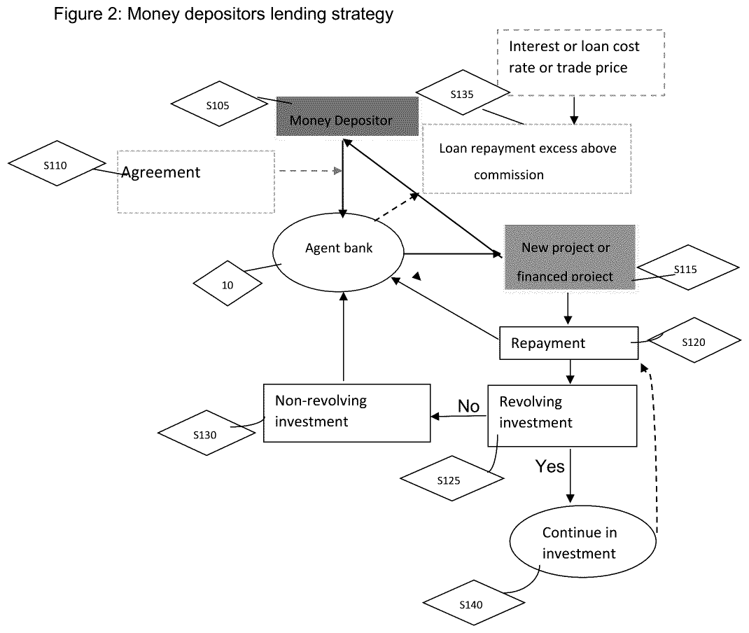

FIG. 2: Depicts money depositors lending strategy by which money depositors have opportunity to buy loan share by their deposit from the project already financed by the bank where the deposit existed or new entrepreneur/borrowers projects to administer the portion of loan share investment under the agent bank (CABS-AT) 10 which stated as one embodiment of the present invention. In step S105, money depositors at bank can be where the bank adopted agent bank (CABS-AT) 10 and receive saving interest rate on deposit amount or can be whose deposit under incubation by agent bank (CABS-AT) 10 where the deposit doesn't have deposit interest rate or dividend. So the depositor that wishes to move to investor position in deposit period can consult the bank and establishes agreement, in step S110, with the agent bank (CABS-AT) 10 to finance the deposit amount on new or already financed entrepreneur/borrower's project, in step S115, to have full or portion of loan share of the total loan disbursement. So in case the bank have stayed paying deposit interest rate or dividend as soon as the depositor move to investor position having established agreement, in step S110, with agent bank (CABS-AT) 10, the bank ceases calculating deposit interest rate or dividend on deposited amount and the portion of loan of depositor, in step S105, will be administered under agent bank (CABS-AT) 10. Where the deposit, in step S105, under agent bank (CABS-AT) 10 incubation the depositor can move to investor position having established agreement with agent bank (CABS-AT) 10, in step S110, to finance new or to have portion of loan share on already financed entrepreneur/borrower project, in step S115. While the project financed by investor, under step S115, before has started repaying the loan periodically to the investor through agent bank (CABS-AT) 10, an investor establishes agreement with the agent bank (CABS-AT) 10 in order the loan repayment to be administered under revolving lending strategy where reinvestment of repayment allowed or under non-revolving lending strategy where reinvestment of repayments is not allowed. So according to agreement between an investor/depositor, in step S105, and the agent bank (CABS-AT) 10 the loan repayments, in step S120, recouped from financed projects, in step S115, can be revolving investment, in step S125, where repayment reinvestment allowed otherwise according to agreement between the investor/depositor, in step S105, with the agent bank (CABS-AT) 10 the loan repayment can be termed as non-revolving investment where repayment reinvestment is not allowed, in step S130, and the agent bank (CABS-AT) 10 can collect commission on loan interest rate or loan cost rate or profit rate or trade price and the loan repayment excess above the agent bank (CABS-AT) commission, in step S135, will be credited into investor account, in step S105. So according to agreement between the investor, in step S105, with agent bank (CABS-AT) 10 the loan repayment can be reinvested in multiple projects, in step S140. While the loan repayment recouped from entrepreneurs/borrowers' projects into central account of the agent bank (CABS-AT) 10 the portion of principal loan repayment with or without the loan price excess above the agent bank (CABS-AT) 10 commission that can be transferred to investor' account, in step S105, considered for reinvestment based on investor's seniority calculation. This means according to investor's seniority calculation the one that became senior investor will be given repayment reinvestment priority.

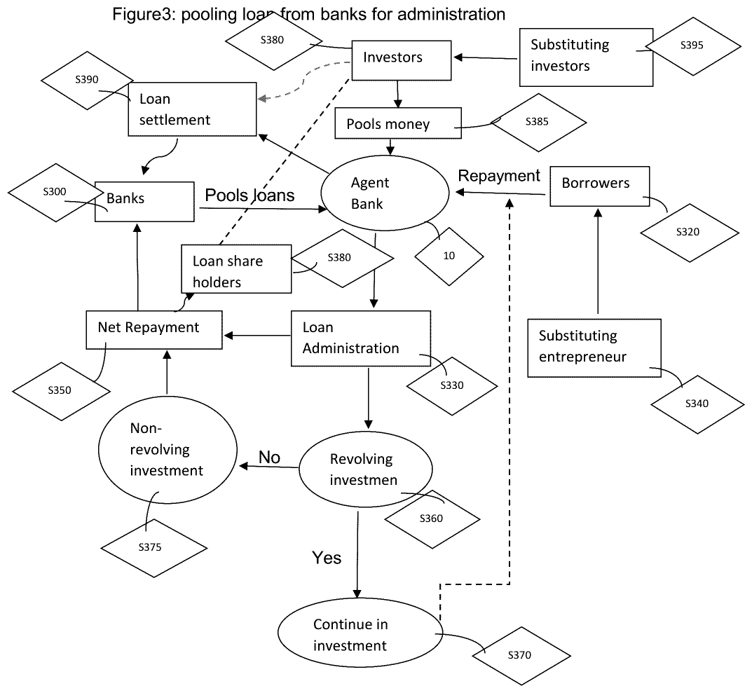

FIG. 3: Depicts pooling loans from banks for administration to transfer credit and liquidity risks of banks where the loans pooled to investors and entrepreneurs/borrowers in order to benefit the banks and investors loan interest rate or loan cost rate or profit rate or trade price calculated on remaining loan balance excess above the agent bank (CABS-AT) 10 commission, which is another embodiment of the present invention. One of the duty of the agent bank (CABS-AT) 10 is pooling loans from banks, in step S300, along with the borrowers, in step S320, to administer the loan, in step S330, by transferring the credit and liquidity risks to substituting entrepreneur, in step S340, to transfer the repayment excess above the agent bank (CABS-AT) 10's commission, in step S350, to loans originated banks' accounts, in step S300. This mechanism helps loan originated banks, in step S300, while the agent bank (CABS-AT) 10 works as independent or a unit of a bank to pool loans in recommendation based on profile of debtors from bank having established precaution agreement with the bank without removing the asset from balance sheet of the bank to administer the loan applying substitution strategy, in step S300, when the borrower fail or deems fail to pay the loan according to agreement with the bank, in step S300. This mechanism helps to alleviate non-performing asset from banks, in step S300, where the loans pooled in order to maintain sustainability and profitability the of banks by transferring credit and liquidity risks of the banks to new entrants entrepreneur/borrower that can operates the business with own fund in full-fledge business of the withdrawing borrower that could repossess the property should the loan repayment effectively recouped. So the benefits of the new entrepreneur is the profit of the business excess above the loan repayment. While the loan pooled from banks administer by the agent bank (CABS-AT) 10, depositors that wish to be an investor can buy loan share on loans pooled and became under administration of the agent bank (CABS-AT) 10. These depositors moved to investor position establish agreement with the agent bank (CABS-AT) 10 on the portion of their loan share repayments to be administered under revolving lending strategy where repayment reinvestment allowed, in step S360, and to continue the loan repayment reinvestment in multiple projects, in step 370, while the agent bank (CABS-AT) 10 collects commission on loan interest rate or loan cost rate or profit rate or trade price rate which calculates on the remaining balance of the loan. Otherwise the loan is to be administered under non-revolving lending strategy where reinvestment of loan repayments is not allowed, in step S375, to transfer the repayment excess above the agent bank (CABS-AT) 10 commission into bank's loan shareholders or investors' accounts, in step S380.

The other function of agent bank (CABS-AT) 10 is pooling loans from banks, in step S300, to administer the loan by making investors, in step S380, to pay the loan amount through agent bank (CABS-AT) 10, in step S385, to settle the loan, in step S390, and remove the loan balance from balance sheet of the banks, in step S300. While the existing investor fail to continue the loan transaction the agent bank (CABS-AT) 10 sell the portion of loan to new entrant investor, in step S395, that can pay the withdrawing investor the remaining unpaid principal loan. The investors that settled the pooled loan have special agreement with the agent bank (CABS-AT) 10 to administer the pooled loan, in step S330, on behalf of them by substituting entrepreneur, in step S340, to transfer credit and liquidity risks to new entrant entrepreneur when the existing borrower deems fail to pay the loan repayment and to credit repayment excess above the agent bank (CABS-AT) 10 commission on loan interest rate or loan cost rate or profit rate or trade price rate, in step S350, into investors account, in step 380. So according to agreement between the investors, in step S380, and the agent bank (CABS-AT) 10 the repayments collected can be reinvested in multiple projects, in step S370, so as to the investors have loan interest rate or loan cost rate or profit rate or trade price rate, which can be calculated on remaining loan balance, excess above the agent bank (CABS-AT) 10 commission. Otherwise should the investors establish agreement with agent bank (CABS-AT) 10 in non-revolving repayment investment strategy where repayment reinvestment is not allowed, in step S375, the portion of loan repayment excess above the agent bank (CABS-AT) 10 commission, in step S350, credits into investors real account, in step S380.

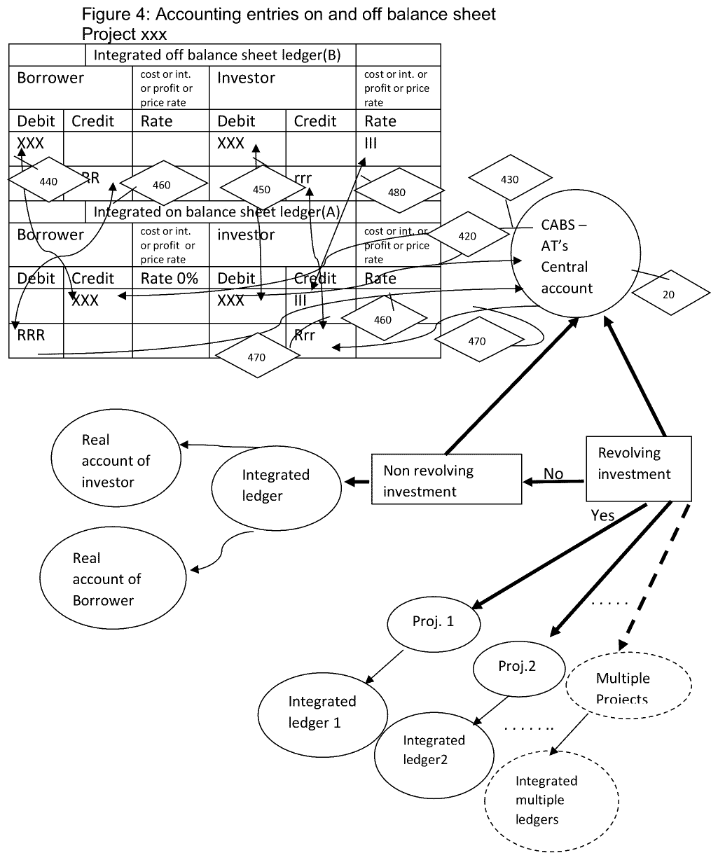

FIG. 4: Depicts loan transaction entries on and off balance sheet for investors' real account integrated with off balance sheet loan ledger linked with entrepreneurs/borrowers' real account integrated with off balance sheet loan ledger linked with project xxx which is another embodiment of the present invention. Once tri-party agreement established among investor, entrepreneur and the agent bank (CABS-AT) 10 itself, investor and entrepreneur requested to open bank accounts for purpose of loan transaction. To disburse loan from investor's real account into entrepreneur's real account the agent bank (CABS-AT) 10 pools money from investor by debiting the account, in step 420, and pools into CABS-AT's central account 20 which later transfers to borrower by crediting the account, in step 430. As soon as the real account opened in the name of investor and entrepreneur/borrower as denoted by (A) a replicate off balance sheet ledger as denoted by (B) to administer the loan after disbursement created in the name of borrower along with the project which integrated with investor ledger. So as the borrower real account credited, in step 430, the borrower off balance sheet ledger debited, in step 440, and simultaneously the investor account on off balance sheet ledger debited, in step 450. Once the business run by the borrower the agent bank (CABS-AT) 10 debits in established computerized system the borrower's account, in step 460, and the same amount credits the borrower's loan ledger on the off balance sheet. The loan repayment set by the agent bank (CABS-AT) 10 for borrower first enable to clear the loan price such as loan interest rate or loan cost rate or profit rate or trade price rate calculated on the remaining principal loan balance and the excess above the loan price amount credits the principal loan balance, in step 460, on off balance sheet ledgers of borrower. At the same time the system set by the agent bank (CABS-AT) 10 credits proportional loan repayment of the investor's investment balance on borrower's project, which is excess above the agent bank (CABS-AT) 10 commission on loan interest rate or loan cost rate or profit rate or trade price rate calculated on the remaining loan balance, in step 470, in to investor's real account and at the same time proportional principal loan repayment amount credits investor's disbursement ledger on off balance sheet to calculate loan interest rate or loan cost rate or profit rate or trade price rate on the remaining disbursement principal balance, in step 480. According to agreement between investor and entrepreneur/borrower the loan repayments can be revolving investment in order the investor invest the loan repayments that recouped by agent bank (CABS-AT) 10 into CABS-AT's central account 20 through computerised system in different borrowers projects and in different loan interest rate or cost rate or profit rate or trade price rate by establishing multiple loans ledgers integrated with investor's investments ledger according to types of loan interest rate or cost rate or profit rate or trade price rate based on seniority of investor's investment. The agent bank (CABS-AT) 10 set a system that can calculate loan price such as loan interest rate or cost rate or profit rate or trade price rate on disbursement loan balance of investor's ledgers either to include in reinvestment or periodically credits into investor's real bank account. Otherwise if the agreement between the investor and the agent bank (CABS-AT) 10 is non-revolving investment where loan repayment is not allowed to reinvest, the loan repayments credit into investor's real account by debiting the borrowers account through CABS-AT's central account 20 and at the same time portion of off balance sheet outstanding loan ledger's balance of the borrower clears by repayment set for borrower and proportional loan repayment that includes loan price clears investor's portion of outstanding disbursement balance after the agent bank (CABS-AT) has collected its commission on loan price that can be periodically credited into investor's real account.

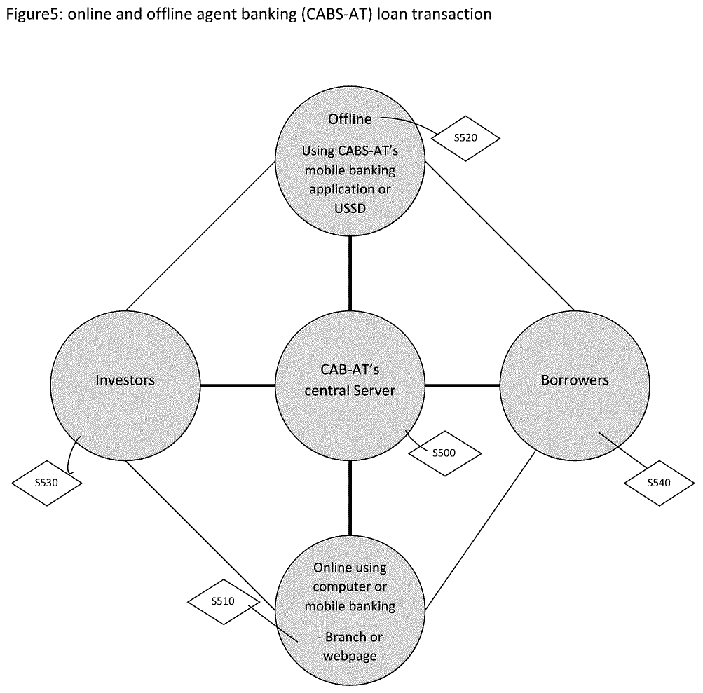

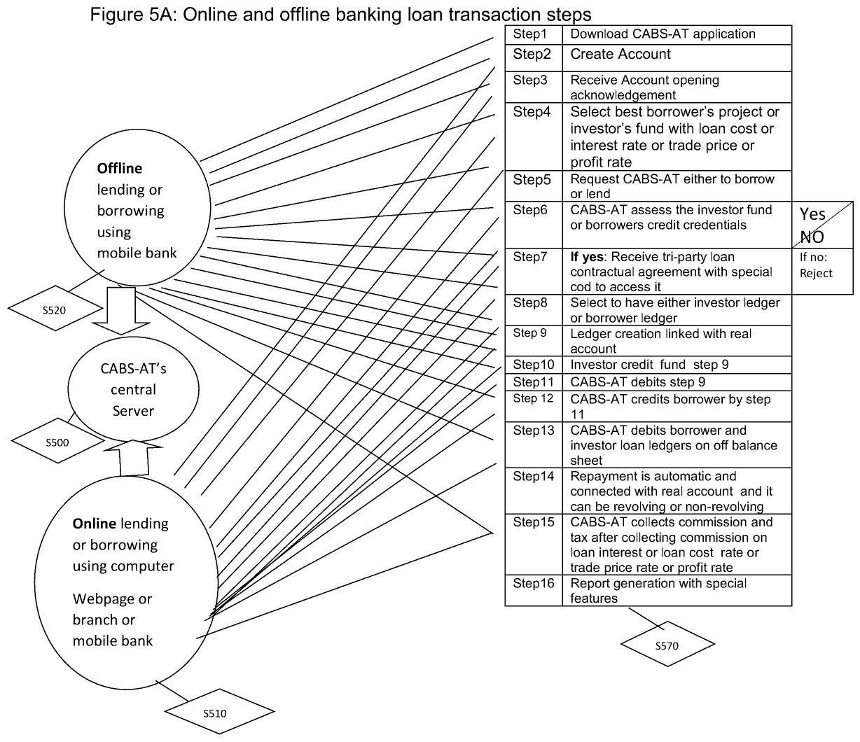

FIG. 5: Depicts online and offline banking loan transaction under which the agent bank (CABS-AT) 10 administers investors fund from inception of loan disbursement to entrepreneurs/borrowers up to loan settlement governing the loan transaction under one of the tree lending strategies of the agent bank (CABS-AT) 10 to benefit investors loan interest arte or loan cost rate or profit rate or trade price rate excess above the agent bank (CABS-AT) 10 commission which calculates on remaining balance of disbursed loan availed on investors and entrepreneurs/borrowers' integrated loan ledgers is another embodiment of the present invention. The loan transaction between investor and entrepreneur/borrower that carry out through the agent bank (CABS-AT) 10 connected with CABS-AT's server, in step S500, can be through online using internet and computer and mobile banking or can be through offline mobile banking using USSD code or CABS-AT's mobile banking application. Offline CABS-AT application and the software that could be installed on computer to work using internet connected with the CABS-AT central server, in step S500. The offline and online banking application is user friendliness by which parties that could involve in loan transaction can understand easily the application and get into loan transaction easily, the application has risk mitigation mechanism to use the system having protected fraudulent in high security, the application accommodates feature opportunities by which the loan transaction between investor and entrepreneur/borrower and incubation of investors and entrepreneurs/borrowers can be easily carry out and should be accessible for online and offline deposit mobilization to benefit depositors loan interest rate or loan cost rate or profit rate or trade price rate when their deposits reach acceptable loanable fund and invest by the agent bank (CABS-AT) on entrepreneurs/borrowers' projects after the agent bank has collected commission thereon, fund transfer using investors' fund to reach local fund easily to recipients from which the investor benefit foreign currencies which enable them to participate in international loan transaction using agent bank (CABS-AT) 10 having maintained the transaction through CABS-AT's central server, in step S500, and other loan transactions governed by local and international protocol.

So the system must provide a feasible projects of entrepreneurs for investors to finance where investors and entrepreneurs are not known or known to one another. The system must analyse the investors' funding source in order to assure whether the investors qualify in loan transaction. The system must assess the feasibility of the entrepreneur as well as the project before entering into a loan contract so as to refine the qualification of entrepreneurs for investors' loan. The system must administer the loan on off balance sheet after disbursement in an authentic manner to prevent moral hazard of the parties involved in the loan transaction. The system must transfer credit risk and liquidity risk to investors and entrepreneurs by not holding the disbursed fund on the agent bank (CABS-AT) 10 balance sheet. The system must ensure that the collateral pledged against the loan disbursed from an investor's account is sufficient to cover loan loss. The system must request the default amount beyond the original remaining loan balance from insurance company in order to reimburse it according to the agreement between the entrepreneur/borrower and the insurance company. The system must rent the project to a new entrant entrepreneur that has the same project interest when the existing borrower fail to pay the investor's loan according credit culture of agent bank (CABS-AT) 10 until the loan is settled holding the collateral and preventing ownership transfer to third party. The system must accommodate the new entrant investor that pay the withdrawing investor's remaining unpaid principal disbursed loan amount and the withdrawing investor's benefits which is unpaid loan interest rate or loan cost rate or profit rate or trade price rate and collects onetime fee for the agent bank (CABS-AT) from withdrawing investor. The system must ensure that the service deliverables by CABS-AT's central server, in step S500, meets the needs and expectations of the client/customer, i.e., investors and entrepreneurs. The system must accommodates international transaction like fund transfer, import, export and international investment using foreign and local investors' fund. The system must collect the agent bank (CABS-AT) commission on interest rate or loan cost rate or profit rate or trade price rate or other commissions and fees from investors based on the three lending strategies of the agent bank (CABS-AT) 10. The system must also credit the portion of principal loan amount and the loan interest rate or loan cost or profit rate or trade price or other commission excess above the agent bank (CABS-AT) 10 commission into investor's account and must reinvest the repayments collected according to investment seniority of investor per agreement between investors and entrepreneurs/borrowers.

In step S500, the agent bank (CABS-AT) 10 has a central server that can accommodate the loan transactions, loan administration and international fund transfer into individual's account. This CAB-AT's central server, S500, with support of computer helps to hold daily loan transaction run by investor and entrepreneur/borrower and banks' loan administration through agent bank (CABS-AT) 10 by reading and writing shared database to handle incubating deposits, investors, entrepreneurs/borrowers and banks' loan administration. So in order to secure the database from unforeseen event the agent bank (CABS-AT) 10 holds daily back up on hard disk or backup storage device. CABS-AT's central server, in step S500, can be application server or traditional or database server from which the agent bank (CABS-AT) 10 can take back up at end of business day using external hardware or backup storage device. The agent bank (CABS-AT) 10 can use serverless computing and application in order to make the loan transaction and administration and deposit incubation seamless having established strong users data protection mechanism and enable to have periodically users data backup. In step S510, the agent bank (CABS-AT) 10 handles loan transaction of investors and entrepreneur/borrowers online using internet that connected with server, step S500. The agent bank (CABS-AT) 10 uses computerized webpage by which every user of the loan transaction services can create account for deposit to be incubated or to be an investor to finance loan to entrepreneur/borrower or to borrow money from one or more investor through the agent bank (CABS-AT) 10. So this internet based webpage having connected with web server helps users of loan transaction either to finance loan or access fund whichever preferred comfort zone having applied one of the three lending strategies of the agent bank (CABS-AT) 10. The agent bank (CABS-AT) 10 through computerized branches handles loan transaction of investors and entrepreneurs/borrowers, and banks' loan administration when the users approach the bank physically. CABS-AT's software that installed on computers of the agent bank (CABS-AT) 10 branches link transaction data to the CABS-AT's central server, in step S500. Using internet based CABS-AT mobile banking application investor and entrepreneur/borrower can transact loan and can incubate deposits for prospective borrower's business finance at national and international level having kept local and international loan transaction legal protocol. In step S520, the agent bank (CABS-AT) 10 handles loan transaction and deposit incubation for prospective business finance using offline mobile banking. This offline and online mobile banking requires acceptable mobile apparatus and SIM card that can accept USSD, unstructured supplementary service data, code or CABS-AT downloadable mobile banking application which enable the users to transact loans, access disbursed or borrowed own loan balance, access loan prices which can be loan interest rate or loan cost rate or profit rate or trade price rate, repayment reinvestment balance according investors' investment seniority and alternative potential investors and feasible projects for finance. The agent bank (CABS-AT) 10 can mobilize deposit for incubation or for investment in order to pay in turn the investment returns to depositor without having paid them deposit price. So investors, in step S530, can transact loans with borrowers, in step S540, using either online or offline CABS-AT and the transaction of which can be handled through CABS-AT's central server, in step S500. So in step S530, the investors can access feasible projects for finance either online or offline CABS-AT and the loan transaction and administration of which to be handled by the agent bank (CABS-AT) 10. In step S540, the borrowers also can access potential investors to get fund online or offline CABS-AT through the agent bank (CABS-AT) 10. So the investor and borrower can have earlier affiliation or not but the loan transaction among them can be treated using one of the agent bank (CABS-AT) 10 three lending strategies. The offline and online system adopted by the agent bank (CABS-AT) 10 enable the users to access disbursed and remaining loan balance, loan interest rate or loan cost rate or profit rate or trade price rate calculated on the remaining loan balance, deposit incubation status to apply for investor position, portion of fund invested by agent bank (CABS-AT) 10 according to investor's investment seniority, status of loan, new alternative investment solution provided by the agent bank (CABS-AT) 10, investors' foreign currency balance and international investment status, letter based daily periodic information about investor and entrepreneur/borrower loan transaction on specific related project, periodic report on loan and deposit incubation status generate by agent bank (CABS-AT) 10 and enable to access loan transaction advanced status and operation applications that can be developed based on this application.

FIG. 5A: Depicts online and offline banking loan transaction steps. In step S500, the CABS-AT's central server plays important roles in accommodating users request and holding users, that are involved in loan transaction, daily transaction data in order to make the agent bank (CABS-AT) 10 business transaction seamless. The loan transaction and administration that could be carried out either through online, in step S510, using internet or offline, in step S520, using USSD code or CABS-AT application has steps in processing of the loan transaction and administration. In step S510, loan transaction and administration and fund transfer service users can use online application or software using internet through dedicated webpage, branches or mobile banking to use the agent bank (CABS-AT) 10 services using protocols in step S570. In step S520, users of agent bank (CABS-AT) 10 services to lend or borrow or fund transfer use offline mobile banking that applies USSD code or CABS-AT mobile banking application to use protocols in step S570. The users in online lending or borrowing in step S570 can create account in step 2 by which the users can fill out personal or personal business or the company's information with lending or borrowing request which can be used by agent bank (CABS-AT) 10 exclusively without exposing users data to harmful events. While the users want to use offline mobile banking in step S520 the users must fix USSD code or download CABS-AT mobile application in step 1 on acceptable mobile apparatus and open account in step 2 by feeding personal or business information with lending or borrowing request on the form provided by offline mobile or online agent banking(CABS-AT) 10. Based on the users request on online or offline agent banking (CABS-AT) 10 the CABS-AT's central server, in step S500, respond acknowledgement for account opening by users in step 3. So according to users' interest in step 4 the system provides for users to select either feasible project for finance or potential investor's fund having considered the best fitted loan interest rate or loan cost rate or profit rate or trade price rate bearing in mind to use one of the three lending strategies of agent bank (CABS-AT) 10. In step 5 the system provides options to users either to lend fund or borrow fund from investor using the agent bank (CABS-AT) 10. In step 6 the agent bank (CABS-AT) 10 assess the investor's legitimacy funding sources or the borrower's credit credentials already filled in step 2 having power of accepting or rejecting users request based on specific criterion. In step 7 the system provides users' assessment result either to establish tri-party agreement among investor, entrepreneur/borrower and the agent bank (CABS-AT) 10 having given to users special code to access their loan transaction either through branches, mobile banking or webpage dedicated for the agent bank (CABS-AT) 10 services but if the system consider the user incapable to proceed the loan transaction or administration the system reject the application of the users. In step 8 the system provides options to users to select either off balance sheet investor or borrower ledger in order to make easy loan administration after disbursement and enable users to access it using the access code given is step 7. In step 9 the system provides forms to users to link off balance sheet ledger created in step 8 with real bank account purposely opened for loan transaction in step 2. In step 10 the system invites investor to credit investment fund into real account in step 9. In step 11 the agent bank (CABS-AT) 10 pools the fund of investor in step 10 into CABS-AT central account 20 and in step 12 the agent bank (CABS-AT) 10 credits borrower's real account created in step 9 by required pooled loan amount in step 11. In step 13 the system simultaneously debits investor's off balance sheet ledger by portion of fund disbursed amount and borrowers off balance sheet ledger by total disbursed loan amount integrating the investor and borrower's loan ledger one another on specific financed project. In step 14 the system pools loan repayment on loan repayment date from real account of borrower into CABS-AT's central account 20 and apply loan repayment revolving investment, where reinvestments of repayment is allowed, or non-revolving investment, where reinvestment of repayments is not allowed, where principal repayment and loan price credited into real account of investor, according to step 9, based on one of the tree lending strategies of agent bank (CABS-AT) 10 agreement established in step 7. In step 15 the system calculates the agent bank (CABS-AT) 10 commission and tax for government on excess above agent bank (CABS-AT) 10 commission on loan interest rate or loan cost rate or profit rate or trade price rate that will be given to investor or for banks whose loan under agent bank (CABS-AT) 10 administration. In step 16 the system provides loan transaction report per users' request and for agent bank (CABS-AT) 10 periodic financial reports with industry analysis and other required reporting features. The report includes investor fund incubation status and the performance of loan given to entrepreneur/borrower with support of loan status rating scale and the lending strategies applied on the project by the agent bank (CABS-AT) 10.

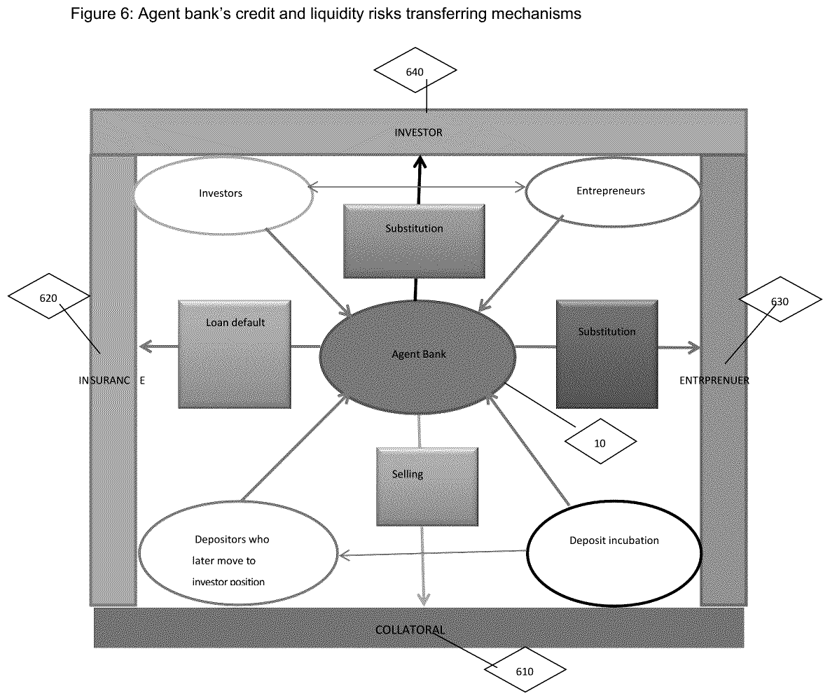

FIG. 6: Depicts agent bank (CABS-AT) 10's credit and liquidity risks transferring mechanisms to investors, entrepreneurs/borrowers, insurance and collateral is another embodiment of the present invention. The main purpose of Agent bank (CABS-AT) 10 is to transfer credit and liquidity risks to investors and entrepreneurs/borrowers and in turn manage risk of parties involved in loan transaction in order to maintain mutual benefit for parties involved in loan transaction. Though investor and entrepreneur have earlier affiliation collateral pledging by entrepreneur/borrower is optional, where there is no affiliation among investor and entrepreneur/borrower collateral pledging by entrepreneur/borrower is mandatory. Even though the agent bank (CABS-AT) 10 returns the properties pledged by entrepreneur/borrower after applying investor and entrepreneur/borrower's substitution strategies in order to collect the repayment in sustainable manner, where there is no alternative solution to recoup the loan disbursed to entrepreneur/borrower from investor the agent bank (CABS-AT) 10, in step 610, sells the pledged collateral to public in order to recoup the loan price as well as the principal loan and the agent bank (CABS-AT) 10 commission and administrative expenses and in this case credit and liquidity risks of the bank transfers to the collateral pledged. Where there is no affiliation between investor and entrepreneur/borrower the borrower obliged to engage with insurance in order to get insurance coverage for the default loan amount of the entrepreneur/borrower by paying insurance premium to insurance company per annum. So where there is default of loan repayment by entrepreneur/borrower the insurance company cover immediately the loan default amount per the agreement between entrepreneur/borrower and the insurance company and so credit and liquidity risks transfer to insurance company, in step 620. In order to manage credit and liquidity risks, the agent bank (CABS-AT) 10 manage risks of the entrepreneur/borrower's business by applying borrower's substitution strategy in order to maintain sustainability of repayment recouping and credit and liquidity risks of the agent bank (CABS-AT) 10 transfers, in step 630, to new entrant entrepreneur that permitted to work in full-fledged borrower's business without property ownership transfer. Per the agent bank (CABS-AT) 10 substitution strategies investor that requested to withdraw the loan transaction during the loan period the agent bank (CABS-AT) 10 substitutes the withdrawing investor by new entrant investor, that has capacity to settle the remaining uncollected principal loan, that has the same project investment interest and the credit and liquidity risk of the agent bank (CABS-AT) 10 transfers, in step 640, to new entrant investor.

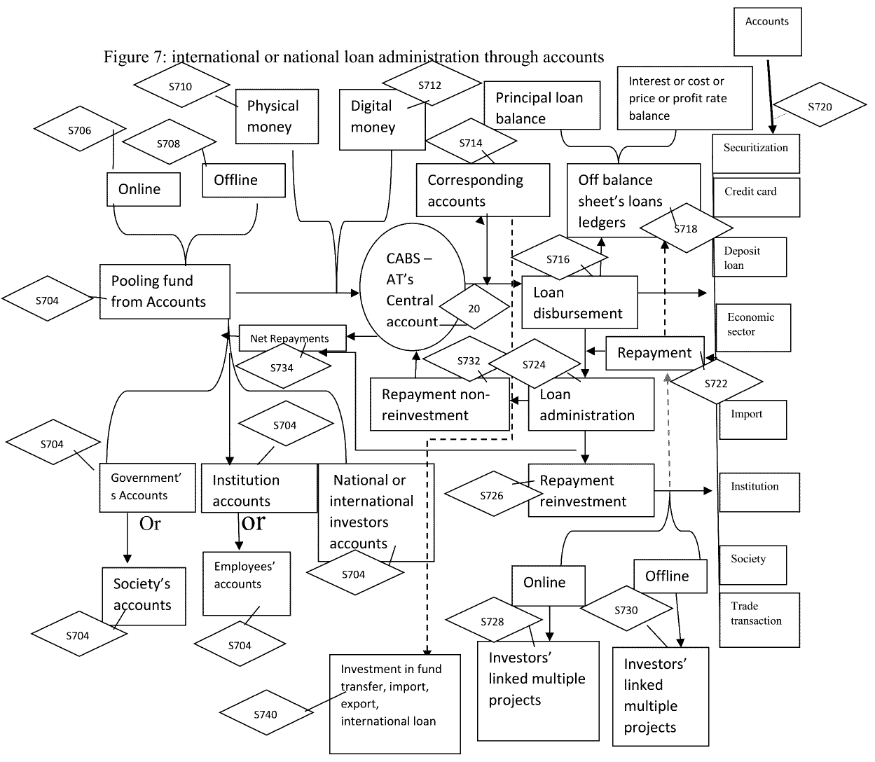

FIG. 7: Depicts international or national loan transaction through accounts to administer investors loan funding from accounts or incubated funding accounts to entrepreneurs/borrowers' accounts by the agent bank (CABS-AT) 10 through CABS-AT's central account 20 or control operating account to benefit into investors ‘accounts loan interest rate or loan cost rate or profit rate or trade price rate after the agent bank has collected its commission thereon which is another embodiment of the present invention. The agent bank (CABS-AT) 10 pools funds from investors' accounts or incubated fund accounts, which can be government, Institution, society, employees, or national and international investors, according to step S704, either online using internet, in step S706, through mobile banking, bank's branches or webpage using computer or offline, in step S708, using mobile banking having CABS-AT′ application or USSD code based on the agreement between investors and the agent bank (CABS-AT) 10 into CABS-AT's central account 20. The fund of investors that pooled into CABS-AT′ central account 20 can be physical money, in step S710, where there is possibility of depositing physical money into real accounts by investors or the pooled money can be digital money, in step S712, based on the rules and regulation of central bank where central bank account that can facilitates transaction among different banks' depositors established. The digital money can be any electronic money including cryptocurrency, where loan transaction needed in cryptocurrency, which can be termed as real money can be pooled into CABS-AT's central account 20 having kept protocol of the countries, where the loan transaction carry out, income tax regulation. The money that can be pooled based on agreement between investors and agent bank (CABS-AT) 10 can be from any banks including at agent bank (CABS-AT) 10 incubated fund accounts but the system stretched by the agent bank (CABS-AT) 10 enables to pool the money from different accounts into CABS-AT's central account 20 and simultaneously enable to manage the real accounts and off-balance sheet loan ledgers opened in the name of investor integrated with entrepreneur/borrower for purpose of loan transaction management. So the CABS-AT's serverless or server database enable to accommodate funds transfer from different banks investors' accounts either for investment on entrepreneur/borrowers projects or for purpose of fund incubation for prospective business finance under management of the agent bank (CABS-AT) 10. The correspondent account, in step S714, opened in the name of the agent bank (CABS-AT) 10 helps to facilitate pooling different international currencies from international investors either for deposit incubation or international investment on selected entrepreneurs/borrowers' projects through the agent bank (CABS-AT) 10. While international investors transfer fund into the CABS-AT's correspondent account, in step S714, having established prior agreement with the agent bank (CAB-AT) 10 real accounts integrated with off balance sheet loan ledgers open by the agent bank (CABS-AT) 10 without deposit price for purpose of fund management after disbursement on entrepreneurs/borrowers projects. So funds pooled from investors accounts disburse, in step S716, for different business project of the entrepreneurs/borrowers having established off balance sheet ledgers, in step S718, integrated with real accounts in the name of each investors and entrepreneurs/borrowers in order to manage the disbursed loan and recouping principal loan along with loan price having calculated loan interest rate or loan cost rate or profit rate or trade price rate on the remaining uncollected principal loan. In step S720, the pooled funds, in step S704, invested in loan securitization by pooling loans from bank the agent bank (CABS-AT) 10 can settle the loan balance from balance sheet of the bank using investors fund to administer the loan applying one of the three agent bank (CABS-AT) 10 lending strategies. The pooled fund, in step S704, can be invested on either international or national credit card having kept international or national protocols and applying one of the three agent bank (CABS-AT) 10 lending strategies. The pooled fund, in step S704, can be invested in deposit loan where a depositors can overdraw the balance to certain limit according to agreement between the agent bank (CABS-AT) 10 and depositor having applied one of the three lending strategies of the agent bank (CABS-AT) 10. The pooled funds, in step S704, can be invested in beneficial economic sector where the government as well as the society would be benefited having applied one of the three lending strategies of agent bank (CABS-AT) 10. The pooled funds, in step S704, can be invested in import having established disbursement agreement with bank which later lend the loan to importer in local currency having applied the three lending strategies of the agent bank (CABS-AT) 10 and international transaction settles by incubated fund at corresponding account in step S714. The pooled funds, in step S704, can be invested in institutions, like financial and non-financial organization financial need, having applied one of the three lending strategies of the agent bank (CABS-AT) 10. The pooled funds, in step S704, can be invested in society where entrepreneurs/borrowers can be in group or individual with their viable project having applied the tree lending strategies of the agent bank (CABS-AT) 10. The pooled funds, in step S704, can be invested in trade transaction which can be settled by borrower once with forward or spot or future spot trade price rate. The system adopted by the agent bank (CABS-AT) 10 automatically collects repayments, in step S722, which include the portion of principal loan amount and the loan price from borrowers accounts, stated in step S720, in order to pay the repayments excess above the agent bank (CABS-AT) 10 commission on loan interest rate or loan cost rate or profit rate or trade price rate into investors' accounts, in step S704 and simultaneously the system adopted by the agent bank (CABS-AT) 10 credit the same proportional repayments' amount into investors and by full repayment amount into entrepreneurs/borrowers' off balance sheet loan ledgers, in step S718, by which the agent bank (CABS-AT) 10 administer principal loan and loan price calculation and repayments. After the loan has disbursed to entrepreneurs/borrowers the loan administration, in step S724, carry out by the agent bank (CABS-AT) 10 in order to make loan repayments sustainable by mitigating the entrepreneur/borrowers' business credit and liquidity risks. According to agreement between investors and the agent bank (CABS-AT) 10 the repayments recouped can be reinvested, in step S726, on different entrepreneurs/borrowers' projects in order to benefit investors, loan interest rate or loan cost rate or profit rate or trade price rate according to their investment seniority. The repayment recouped can be reinvested online having internet, in step S728, through dedicated webpage, branches computers or mobile banking or offline, in step S730, mobile banking in multiple borrowers' projects that have linkage with investors and borrowers' real account integrated with online or offline respective off balance sheet loan ledgers which helps to administer the loan after disbursement. On other hand the repayments recouped either online or offline commission agent banking system (CABS-AT) 10 can periodically credit into investors' accounts should an investors establish agreement with the agent bank (CABS-AT) 10 to select non-revolving investment strategy, where reinvestment of repayments is not allowed, in step S732. Should there is an agreement between the investors and the agent bank (CABS-AT) 10 to collect either only the loan price or the portion of principal repayment without reinvesting them on multiple projects, the net repayment, in step S734, which is excess above the agent bank (CABS-AT) 10 commission on loan interest rate or loan cost rate or profit rate or trade price rate credits into investors' accounts, in step S704. so whenever loan repayment effected from borrowers accounts to credit CABS-AT's central account 20 or control operating account, the agent bank (CABS-AT) 10 collects commission on loan interest rate or loan cost rate or profit rate or trade price rate in whichever the loan can be in revolving or non-revolving lending strategy agreement. In step S740, The agent bank (CABS-AT) 10 also pools foreign currencies from international investors' accounts into the country to lend local entrepreneurs/borrowers in local currency from local investors' accounts, in step S704, to benefit international investors' loan interest rate or profit rate or loan cost rate or trade price rate after the agent bank (CABS-AT) 10 has collected its commission thereon and in this case the local investors enable to possess foreign currencies with their equivalent fund set in their accounts which in turn this fund can be used to pay for international trade transaction settlement, such as for import of goods and services, from which the investors can gain foreign currency exchange profit and the agent bank (CABS-AT010 can collect commission related transaction or these foreign currencies enable investors to participates in international investment in order to get benefits of loan interest rate or loan cost rate or profit rate or trade price rate excess above the agent bank (CABS-AT) 10 commissions having applied one of the three lending strategies of the agent bank (CABS-AT) 10. The pooled fund from investors' accounts, in step S704, can be invested in importers business or exporters business to gain again foreign currencies on behalf of local investors that as well gain interest rate or loan cost rate or profit rate or trade price rate excess above the agent bank (CABS-AT) 10 commission calculated thereon. The pooled fund from investors' accounts, in step S704, can be used to pay local fund transfer beneficiaries and export financing which in turn enable them to gain foreign currencies which helps them to participate in international investment even though the agent bank (CABS-AT) 10 collects service charges related with international fund transfer. In all cases of transactions, in step S740, the investors and the agent bank (CABS-AT) 10 need to have prior agreement having applied the three lending strategies of the agent bank (CABS-AT) 10. The transaction can be run by the norm of the agent bank (CABS-AT) 10 foreign currencies exchange rates periodical settings.

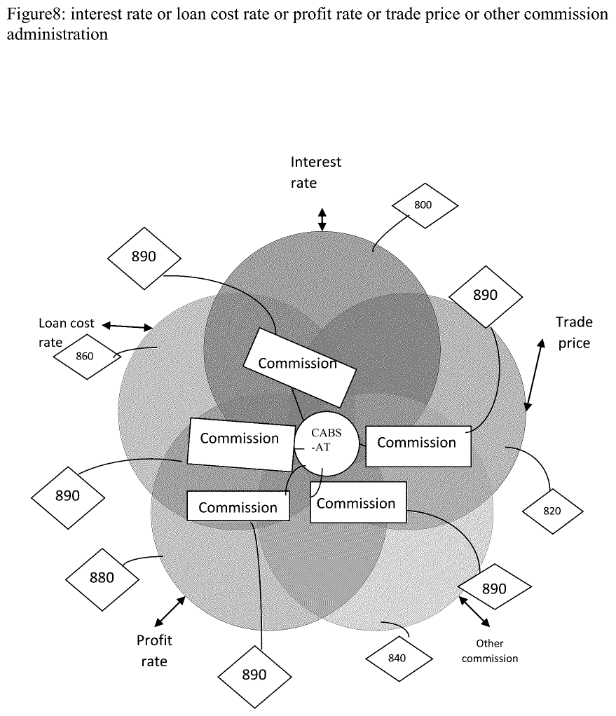

FIG. 8: Depicts loan interest rate or loan cost rate or trade price or profit rate or other commission administration that can be given to investors excess above the agent bank (CABS-AT) 10 commission is also another embodiment of the present invention. The main reason of financing entrepreneur/borrowers' projects by investors is for sake of loan price, which can be loan interest rate or loan cost rate or profit rate or trade price rate, which can be calculated on the remaining unpaid loan balance. The loan price can be loan interest rate, in step 800, which can be market rate or the rate set by the agent bank (CABS-AT) 10 and set in loan contractual agreement to calculate on the remaining principal loan amount to benefit the investors after the agent bank (CABS-AT) 10 has taken commission, in step 890, which is calculated based on commission rate set in loan contractual agreement. While the investors finance borrowers in order to pay for cost of goods of suppliers, the borrower expected to pay the disbursed loan once along with forward or spot trade price, in step 820, which can be calculated according the value of money in the market or set by the agent bank (CABS-AT) 10 having considered the relative value of money in the market after the agent bank (CABS-AT) 10 has collected its commission, step 890, calculated thereon. The agent bank (CABS-AT) 10 can also run money transaction such international and local trade, such as export and fund transfer, Using investors' fund to benefit investors other commission, in step 840, rate set by the agent bank (CABS-AT) 10 after the agent bank (CABS-AT) 10 has collected its commission, in step 890, calculated thereon. After the loan has disbursed on entrepreneurs/borrowers' projects the loan administration intensity on the disbursed loan depends on the size of loan since big loans needs stiff administration whereas small loans need low intensive administration, the agent bank calculate loan cost rate which can increase according to the size of loan, in step 860, having added profit mark up on administrative expense to calculate on loan disbursed on entrepreneurs/borrowers' projects after the agent bank (CABS-AT) 10 has collected its commission, in step 890, calculated thereon. In step 880, wherein the loan transaction agreement among investors, entrepreneurs/borrowers and the agent bank (CABS-AT) 10 is based on profit rate, which can be calculated by agent bank (CABS-AT) 10 or based on market rate, on the profit before tax, the repayments calculated based on profit rate considered as an expense of the entrepreneurs/borrowers to relief them from tax burden after the agent bank (CABS-AT) 10 has collected its commission, in step 890, calculated thereon. In step 890, While the agent bank calculates loan interest rate or trade price rate or other commission rate or loan cost rate or profit rate on investors disbursed fund it collects its commission per transaction, based on the rate set in loan contractual agreement which can be calculated by the agent bank (CABS-AT) 10 having considered financial and non-financial administrative expenses having put profit mark up and the excess above the agent bank (CABS-AT) 10 commission calculated on loan interest rate or trade price rate or other commission or loan cost rate or profit rate on disbursed fund credits into investors' accounts. While international fund transfers through the agent bank (CABS-AT) 10 the investors whose fund can be paid to beneficiary in local currency will be foreign currency beneficial, which leads them to participate in international investment through the agent bank (CABS-AT) 10 and the agent bank (CABS-AT) 10 collects foreign currency fund transfer price having in mind to pay investors in local currency based on their need arise having applied one of the three lending strategies of the agent bank (CABS-AT) 10.

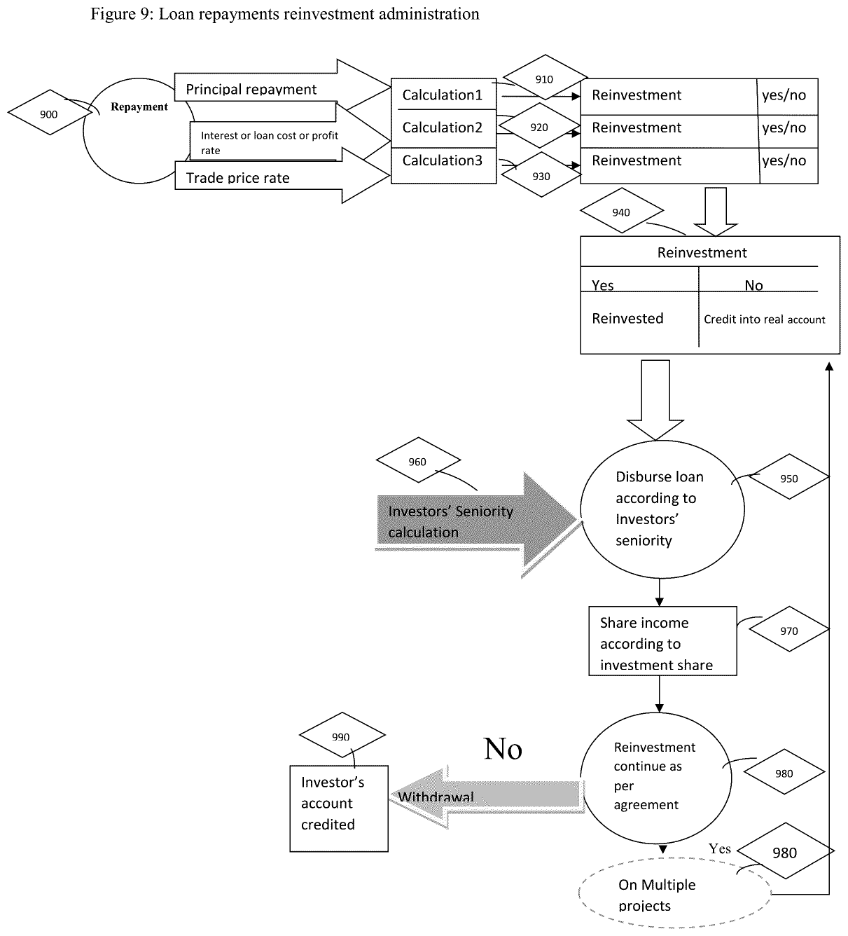

FIG. 9: Loan repayments reinvestment administration under established agreement between investors and agent bank (CABS-AT) 10 to consider the portion of principal repayments and loan interest rate or loan cost rate or profit rate or trade rate price calculated on the remaining loan balance for reinvestment applying one of lending strategies of agent bank (CABS-AT) 10, revolving lending strategy, is another embodiment of the present invention. While the parties involved in loan transaction such as investor, entrepreneur/borrower and the agent bank (CABS-AT) 10 itself get into loan transaction agreement the investor requested to declare reinvestment interest either the portion of principal loan repayment without loan price or repayment with loan price which is excess above the agent bank (CABS-AT) 10 commission to be considered in one of the three lending strategies of the agent bank (CABS-AT) 10, revolving investment strategy where principal loan repayment or repayment including or non-including loan price is to be reinvested by the agent bank (CABS-AT) 10 in multiple projects based on investment seniority of investors. The repayment, in step 900, contains the portion of principal loan repayment and the loan price, such as loan interest rate or loan cost rate or profit rate or trade price rate, excess above the agent bank (CABS-AT) 10 commission. The loan price can be loan interest rate which can be determined according to demand and supply of money in the market or by the agent bank (CABS-AT) 10. Since the loan administration intensity depends on the size of loan disbursed on entrepreneur/borrower's project the loan cost rate which can be considered as loan price can be applied on the remaining balance of loan disbursed to entrepreneur/borrower's project. Where spot transaction carry out to purchase goods from supplier the agent bank (CABS-AT) 10 sell the money to entrepreneur/borrower in spot or future spot or forward trade price rate, which can be considered as loan price, which can be calculated based on the value of money in the market or can be calculated by the agent bank (CABS-AT) 10 having considered relative value of money in the market. Wherein the loan transaction agreement is based on profit rate which can be calculated on the profit of entrepreneur/borrower before tax, the repayment calculated by the agent bank (CABS-AT) 10 considered as expense of an entrepreneur/borrower. While individual investor buy share of loan the agent bank (CABS-AT) 10 immediately establish investor and entrepreneur/borrower's off balance sheet ledger integrated with entrepreneur/borrower's project to record on the same investor's disbursement and borrower's credit amount and calculate thereon the loan price, such as loan interest rate or loan cost rate or profit rate or trade price rate, and put the calculated loan price in separate column on the off balance sheet loan ledger of investor and entrepreneur/borrower independently for purpose of having effective principal loan and loan price administration. While investor disburse a portion of fund to invest on entrepreneur/borrower's project, the investor entitle to have loan share of total lump sum loan disbursed for single entrepreneur/borrower. So while repayment effected by entrepreneur/borrower proportional principal loan repayment calculated, in step 910, and collected according to agreement between the investor and the agent bank (CABS-AT) 10 can be reinvested or credited into investor's real account, in step 940. The loan interest rate can be set based on the market rate or set by the agent bank (CABS-AT) 10, and included in tri-party loan contractual agreement. The loan cost rate can be set by agent bank (CABS-AT) 10 having considered the agent bank (CABS-AT) 10 commission rate and financial and nonfinancial administrative expense and profit mark up. The loan cost rate can be varied according to the size of loan which needs level of intensity of administration. So as the size of loan increases the loan cost rate expected raising since the loan cost rate depends on intensity of the agent bank (CABS-AT) 10 to administer the loan. Profit rate calculated either by agent bank or according to the market and depends on the profit before tax and the repayment calculated based on profit rate considered as expense of entrepreneur/borrower. While interest rate or loan cost rate or profit rate or trade price rate calculated on the remaining unpaid principal balance of investor and entrepreneur/borrower's off balance sheet balance having put the loan interest rate or loan cost rate or profit rate or trade price rate on separate column on the off balance sheet loan ledgers of investor and entrepreneur/borrower independently. In step 920, according to agreement between investor and the agent bank (CABS-AT) 10 the interest rate or loan cost rate or profit rate can be reinvested or credited into investor's real account, in step 940. while the borrower borrow money from investor and settle once after purchasing goods from supplier the agent bank (CABS-AT) 10 calculates spot or forward trade price rate on total loan amount. The trade price rate can be set by the agent bank (CABS-AT) 10 having considered the value of money or relative value of money in the market. So the agent bank (CABS-AT) 10 calculates the trade price rate on investor's portion of principal loan and set on separate column on investor and entrepreneur/borrower's off balance sheet loan ledgers independently. And this calculated spot or forward trade price, in step 930, based on agreement between investor and agent bank (CABS-AT) 10 can be reinvested or credited into investor's real account. in step 940. Portion of principal loan repayment and loan interest or loan cost or profit rate or trade price amount can be reinvested according to investor's investment seniority, in step 950, which can be calculated by the agent bank (CABS-AT) 10, in step 960. While reinvestment carry out by the agent bank (CABS-AT) 10 the loan price as well as portion of principal loan repayments debit the investor and borrower's off balance sheet loan ledgers continuously calculating loan interest rate or loan cost rate or profit rate or trade price rate on the remaining uncollected investor's principal loan balance according to step 970. So reinvestment of portion of principal loan and loan price continue, in step 980, in multiple projects with different loan interest rate or loan cost rate or profit rate or trade price rate having established equivalent agreement based on selected loan price with the agent bank (CABS-AT) 10 to administer these reinvestment at different off balance sheet loan ledgers entitled under investors integrating with corresponding entrepreneur/borrower's projects. Otherwise the investor can withdraw the reinvestment loan transaction by selling the remaining unpaid principal loan amount through the agent bank (CABS-AT) 10 to new entrant investor and the loan price up to date as well principal loan invested amount calculated on off balance sheet loan ledger of the investor credit into investor's real account, in step 990. while loan repayment reinvestment carry out whenever loan repayment effected by the entrepreneur/borrower, the agent bank (CABS-AT) 10 collects commission on loan interest rate or loan cost rate or profit rate or trade price rate calculated on the portion of principal loan of investor that can be given to investor.

What is claimed is:

1. A method for a bank to be an agent for one or more investors' revolving or non-revolving lending money, which can be physical or digital money, through online or offline banking to one or more entrepreneurs/borrowers having established loan contractual agreement among the fund seller and buyer and the agent bank (CABS-AT) itself to collect agreed commission on loan interest rate or profit rate or loan cost rate or trade price rate, which can be spot, future spot or forward rate, which calculates on the remaining loan balance that will be given to investors, comprising:
A) Accessing, by online using internet through computer, webpage, mobile banking and offline mobile banking using agent bank (CABS-AT) application or USSD code that connected with serverless computing and server, comprising:
(1) Established tri-party agreement among investors, entrepreneurs/borrowers and the agent bank (CABS-AT) to Pool fund from plurality of investors' accounts into agent bank (CABS-AT)'s central account or control operating account and finance the fund by agent bank (CABS-AT) on plurality of entrepreneurs/borrowers' projects/business through established accounts maintained at agent bank (CABS-AT) and administer the disbursed loan to plurality of entrepreneurs/borrowers on off balance sheet loan ledgers by the agent bank (CABS-AT) to benefit investors loan interest rate or loan cost rate or profit rate or trade price rate calculated on remaining loan balance after the agent bank (CABS-AT) has collected its agreed commission thereon;
(2) Incubated deposits by the banks adopted the agent bank (CABS-AT) to utilize the fund in short term investment to collect the loaned fund shortly calculating on deposited fund either deposit price or dividends till the deposited money reaches loanable fund where the bank let the depositors/investors invest their fund later on new or already financed entrepreneurs/borrowers' projects through agent bank (CABS-AT), wherein Incubated entrepreneurs either can be applied in substitution strategy or their project can be financed by investors, wherein Incubation of investors and entrepreneurs' fund can also run by full-fledge commission agent banking system (CABS-AT) without paying either deposit price or dividend till the depositors money reaches loanable fund where the agent bank (CABS-AT) pools fund of depositors and invest on plurality of entrepreneurs/borrowers' projects through accounts maintained at agent bank (CABS-AT) to benefit them either interest rate or profit rate or loan cost rate or trade price rate which calculates on the remaining balance of entrepreneurs/borrowers' loan after the agent bank (CABS-AT) has collected its agreed commission thereon while repayments effected from plurality entrepreneurs/borrowers' accounts.
(3) Accessing, tree-truck lending strategies to run commission agent banking system (CABS-AT) through online internet based computer, webpage and mobile banking and offline mobile banking, comprising:
a) Revolving lending strategy, comprising:
receiving entrepreneur's project selection by investor either from market or from commission agent bank (CABS-AT)'s entrepreneurs incubation to lend money to entrepreneur either with collateral where there is no prior partnership established between the fund seller and buyer or without collateral where there is prior partnership established between the fund seller and buyer;
receiving contractual agreement among parties involved in this lending strategy such that investors, entrepreneurs and the agent bank (CABS-AT) using application, wherein the application handles the lending system that focus on many fund sellers to one fund buyer, or one fund seller to many fund buyers or one fund seller to one fund buyer where reinvestment allowed for investors/fund sellers;
wherein the method supported by a system is to process lending money to entrepreneurs/borrowers by investors with or without collateral where prior partnership not established or established respectively and later loan repayments collected reinvested on another entrepreneurs projects where collateral pledging required by entrepreneurs and the system adopted by the agent bank (CABS-AT) calculates investment seniority of investors to reinvest loan repayments according to investors' investment seniority;
reinvesting loan repayments through financial application or computer product which can be carried out by agent bank (CABS-AT) based on one or more investors agreement in loan contractual agreement either including or non-including interest rate or profit rate or loan cost rate or trade price rate calculated on specific selected loan balance which is excess above the agent bank (CABS-AT)′ commission thereon and loan term such as short term or medium term or long term loan since each of which loan term interest rate or profit rate or loan cost rate or trade price rate vary and the loan administration carry out by agent bank (CABS-AT) creating link between one or more investors' fund disbursement ledgers integrated real accounts with one or more entrepreneurs/borrowers loan ledgers integrated real accounts on off balance sheet directly to pay the remaining disbursed fund balance of investors and remaining loan balance of entrepreneurs after the agent bank (CABS-AT) has collected commission on loan interest rate or loan cost rate or profit rate or trade price rate up on repayments effected from plurality of entrepreneurs/borrowers' accounts;
causing financial application or computer product to calculate variety of loan interest rate or profit rate or loan cost rate or trade price rate daily by the agent bank (CABS-AT) on respective plurality of investors and entrepreneurs' loan ledgers remaining loan balance integrated with respective investors and entrepreneurs/borrowers' real accounts independently and set in separate column without capitalizing on principal balance to show the loan price flow on the respective loan ledgers of investors and entrepreneurs/borrowers and reinvest the sum of portion of principal loan repayments along with accrued loan price calculated on the remaining portion of principal loan balance of investors on multiple business projects of entrepreneurs/borrowers;
transferring sustainable interest rate or profit rate or loan cost rate or trade price rate calculated on disbursed loan to entrepreneurs/borrowers into investors' accounts after the agent bank (CABS-AT) has collected its sustainable commission thereon into balance sheet income account;
wherein the method is supported by a system enables investors to invest in multiple projects of entrepreneurs/borrowers while prior projects' loan settled in their due dates;
wherein the method is supported by a system enables investors withdraw from the loan transaction at any time and the agent bank (CABS-AT) sells the remaining principal loan balance of the investors to another interested investors and while entrepreneurs fail to pay investors' loan the entrepreneurs full-fledge business/projects rents to selected entrepreneurs using own working capital considering the business income excess above the loan repayments as profit of new entrant entrepreneurs without property ownership transfer unless otherwise loan disbursed unpaid where the collateral pledged will be sold to recoup disbursed loan;
wherein the method is supported by a system is to charge investors onetime fee while the entrepreneur's project selected by agent bank (CABS-AT) on behalf of the investors based on investment interest on a project.
b) Non-revolving lending strategy, comprising:
receiving entrepreneur's project selection by investor either from market or from commission agent bank (CABS-AT)'s entrepreneurs incubation to lend money to entrepreneur either with collateral where there is no prior partnership established between the fund seller and buyer or without collateral where there is prior partnership established between the fund seller and buyer;
receiving contractual agreement among parties involved in this lending strategy such that investor, entrepreneur/borrower and the agent bank (CABS-AT) using application, wherein the application handles the lending system that focus on many fund sellers to one fund buyer, or one fund seller to many fund buyers or one fund seller to one fund buyer where loan repayments reinvestment not allowed for investors/fund sellers;
wherein the method supported by a system is to process lending money to entrepreneur by investor without establishing agreement with the agent bank (CABS-AT) to reinvest the repayments collected from entrepreneurs and the repayment, which contain the principal loan and loan price, excess above the agent bank (CABS-AT)'s commission periodically credited into investor's specific or general account and the loan transaction can be carried out on investor's fund disbursement ledger integrated real account linked with entrepreneur's loan ledger integrated real account on off balance sheet of the agent bank (CABS-AT) to recoup loan repayments and pay the fund balance held in name of investors and entrepreneur/borrowers and to credit the same into investors' real accounts periodically and to calculate loan interest rate or profit rate or loan cost rate or trade price rate on the remaining principal balance of investor and entrepreneur/borrower on off balance sheet without capitalizing on the principal balance to show repayments and loan price flow and later to credit investors' accounts same after the agent bank (CABS-AT) has collected commission on loan interest rate or loan cost rate or profit rate or trade price rate into its balance sheet income account;
wherein the method supported by a system enables investors to withdraw the loan transaction at any time and the agent bank (CABS-AT) sells the remaining uncollected loan balance of the investors to another interested investors by collecting onetime fee from withdrawing investors and while entrepreneurs/borrowers fail to pay the loan repayments the agent bank (CABS-AT) rents the entrepreneurs' full-fledge business to new entrant entrepreneurs with own working capital without transferring property ownership to benefit the new entrant entrepreneurs the business profit excess above the loan repayments.
c) Money depositors lending strategy, comprising:
receiving investment opportunity request by depositors to have loan share on the project already invested by bank where the money deposited or on new project to get loan interest rate or profit or loan cost rate or trade price rate instead of saving interest rate or dividend after the agent bank (CABS-AT) has collected agreed commission thereon to administer the portion of loan share till settlement;
Wherein the method supported by a system enables investors and the agent bank (CABS-AT) establish loan contractual agreement adopting either revolving or non-revolving lending strategy based on the loan term, such that short term or medium or long term loan, selected by investors and enable to calculate loan interest rate or profit rate or loan cost rate or trade price rate on the remaining investors or entrepreneurs' loan balance maintained at the investors' disbursement fund ledgers integrated real accounts linked with entrepreneur's loan ledger of project integrated real accounts after the agent bank (CABS-AT) has collected commission on investors' loan price while repayments effected from plurality of entrepreneurs/borrowers' real accounts into plurality of investors accounts;
wherein the method supported by a system enables investors to withdraw from the loan transaction and the agent bank (CABS-AT) sells the remaining principal uncollected loan of investors to new entrant investors by charging onetime fee from withdrawing investors and while entrepreneurs fail to pay the loan the entrepreneurs' full-fledge business rents to new entrant entrepreneurs with own working capital to benefit them business profit excess above the loan repayment without property ownership transfer unless otherwise the disbursed loan unable to be recouped;
wherein investors collect sustainable loan interest rate or profit rate or loan cost rate or trade price rate from loan transaction after the agent bank (CABS-AT) has collected sustainable commission from investors' loan price;
wherein entrepreneur's project selected by agent bank (CABS-AT) on behalf of the investors based on investment interest on a project, the system adopted by the agent bank (CABS-AT) charges the investors onetime fec.

2. The method of claim 1, wherein Commission agent banking system (CABS-AT) using financial application or computer product turns, financial or nonfinancial, organization's capital or pension fund into investment in entrepreneurs/borrowers' projects to benefit them sustainable interest rate or profit rate or loan cost rate or trade price rate having applied one of the three agent bank (CABS-AT) lending strategies by establishing agreement between the organizations and commission agent banking system (CABS-AT) to reinvest organizations' repaid fund from entrepreneurs/borrowers in multiple other entrepreneurs/borrowers projects by benefiting them loan interest rate or profit rate or loan cost rate or trade price rate which can in turn either be reinvested or credited into the organization/investor's account after the agent bank (CABS-AT) has collected commission on loan interest rate or loan cost rate or profit rate or trade price rate while each and every loan repayments effected from plurality of entrepreneurs/borrowers' accounts.

3. The method of claim 1, wherein Commission agent banking system (CABS-AT) pools money from Employees' accounts supported by financial application or computer product to invest on their organization or other organization or on entrepreneurs/borrowers' projects to benefit them either sustainable interest rate or profit rate or loan cost rate or trade price rate calculated on the remaining loan balance after the agent bank (CABS-AT) has collected sustainable commission into its balance sheet income account applying one of three agent bank (CABS-AT)'s lending strategies.

4. The method of claim 1, wherein Commission agent banking system (CABS) Pools money from unbanked/under banked society accounts supported by financial application or computer product to invest on entrepreneurs/borrowers' projects having applied one of the tree lending strategies of agent bank (CABS-AT) to benefit them either sustainable interest rate or profit rate or loan cost rate or trade price rate after the agent bank (CABS-AT) has collected commission sustainably thereon into its balance sheet income account.

5. The method of claim 1, wherein Commission agent banking system (CABS) Pools money from local and foreign investors' accounts supported by financial application or computer product to invest on government projects having applied one of the tree lending strategies of agent bank (CABS-AT) and got government's guarantee to benefit them either sustainable interest rate or profit rate or loan cost rate or trade price rate after the agent bank (CABS-AT) has collected sustainable commission thereon into its balance sheet income account.

6. The method of claim 1, wherein Commission agent banking system (CABS-AT) Pools money from governments or international profit or non-profit organizations' accounts supported by financial application or computer product to invest on their preferential countries entrepreneurs/borrowers' projects having got agreement of money seller and buyer's bank which finance entrepreneur/borrower in local currency using one of the agent bank (CABS-AT)'s lending strategies to benefit investors or money sellers international market sustainable interest rate or profit rate or loan cost rate or trade price rate after the agent bank (CABS-AT) has collected sustainable commission into balance sheet income account while repayments effected by entrepreneurs/borrowers' bank in foreign currency.

7. The method of claim 1, wherein Commission agent banking system (CABS-AT) Pools money from local or international investors' accounts supported by financial application or computer product to invest in real estate or on agricultural or non-agricultural processing industries to recoup the loan repayments through sales of real estate in cash or through credit or from rent of industries to users having applied one of the tree agent bank (CABS-AT)'s lending strategies to benefit investors either sustainable interest rate or profit rate or loan cost rate or trade price rate after the agent bank (CABS-AT) has collected sustainable commission thereon into its balance sheet income account.

8. The method of claim 1, wherein Commission agent banking system (CABS-AT) Pools money from investors' accounts supported by financial application or computer product to invest on global economic beneficial farmers' agricultural areas having insurance coverage for export as well as inland use where repayment can be recouped at the sales of harvested crops and per established agreement between the investors and the agent bank (CABS-AT) the repayment recouped from sales of harvested crops reinvested in another agricultural areas to benefit investors either sustainable interest rate or profit rate or loan cost rate or trade price rate after the agent bank has collected sustainable commission thereon into its balance sheet income account having applied one of the three agent bank (CABS-AT)'s lending strategies.

9. The method of claim 1, wherein Commission agent banking system (CABS-AT) Pools money from national or international investors' accounts supported by financial application or computer products to invest in international or inland credit card lending system having established international and local loan transaction agreement between the agent bank (CABS-AT) and credit card users to benefit investors either sustainable interest rate or profit rate or loan cost rate or trade price rate periodically as per agreement of agent bank (CABS-AT) with investors after the agent bank (CABS-AT) has collected sustainable commission thereon into its balance sheet income account having applied investor and entrepreneur's substitution strategies, wherein the new entrant entrepreneur/borrower/credit card holder benefits higher cash return from credit card guarantee while the debt settle.

10. The method of claim 1, wherein Commission agent banking system (CABS) Pools fund from investors' account supported by financial application or computer product to invest on government in case of the government met budget deficit having applied one of the tree agent bank (CABS-AT)'s lending strategies and got government guarantee to benefit them risk free interest rate or profit rate or loan cost rate or trade price rate after the agent bank (CABS-AT) has collected commission thereon into balance sheet income account.

11. The method of claim 1, wherein Commission agent banking system (CABS) Pools money from investors' accounts supported by financial application or computer product to invest on financial institution's money needs for daily operation or loaning to customers or deposit withdrawals having applied the tree lending strategies of agent bank (CABS-AT)'s to benefit them either sustainable interest rate or profit rate or loan cost rate or trade price rate after the agent bank (CABS-AT) has collected sustainable commission thereon into balance sheet income account and the agent bank (CABS-AT) collects commission when repayments recouped from financial institution that have reinvested on same or similar institutions recouped again.

12. The method of claim 1, Wherein Commission agent banking system (CABS-AT) pools money from investors' accounts supported by financial application or computer product to invest in trade, such as for purchase of goods and settle the loan once later by borrower, by issuing derivative securities to investors having applied the tree lending strategies of agent bank (CABS-AT) and forecasting and managing securities' related risks in order to benefit investors sustainable trade price rate, which can be spot or future spot or forward, after the agent bank (CABS-AT) has collected sustainable commission thereon into balance sheet income account.

13. The method of claim 1, wherein Commission agent banking system (CABS-AT) pools money from investors' accounts supported by financial application or computer product to invest in importing basic economic goods applying one of the three lending strategies of agent bank (CABS-AT) to benefit investors interest rate or profit rate or loan cost rate or trade price rate after the agent bank (CABS-AT) has collected commission thereon into its balance sheet income account.

14. The method of claim 1, wherein commission agent banking system (CABS-AT) disregards reserve and capital adequacy regulatory requirement since it doesn't hold deposit for its own benefits by disbursing it to borrowers to get loan price.

15. A system for commission agent bank system (CABS-AT) that enables investors and entrepreneurs/borrowers and the agent bank (CABS-AT) itself to access loan administration of the agent bank (CABS-AT) after disbursement from investors to entrepreneurs/borrowers on real deposit accounts integrated with off balance sheet loan ledgers opened in name of each investors and entrepreneurs/borrowers, comprising:
Any computers and selected mobile configured with the following components:
(A) A component for accessing one or more electronic databases, comprising:
(1) Loan repayment set by agent bank (CABS-AT) for interest bearing loan or non-interest bearing loan is non-taxable progressive instalments that increase according to performance of the business which should be adjusted with future inflation, risk and sensitivity rates to suit the repayments according to the business firm changeable cash inflow and should be considered as expense of the borrowers/entrepreneurs and for salaried person non-taxable equal instalments which do not challenge the individual's living economy can be set.
(2) Commission agent banking system (CABS-AT) applies consensus established in loan contractual agreement that details investors or entrepreneurs substitution strategies of agent bank (CABS-AT), the collateral pledged or not by entrepreneurs/borrowers, interest rate or profit rate or loan cost rate or trade price that will be calculated on the remaining loan balance, the loan repayment, the investment interest of investor on one of the term loan such as short term or medium or long term loan since each term loan's interest rate or profit rate or loan cost rate or trade price rate differs from one another, the interest of the investor to reinvest loan repayment collected from entrepreneur through agent bank (CABS-AT), the agent bank (CABS-AT)'s commission that will be collected from investor's interest rate or profit rate or loan cost rate or trade price and other commission as the cause may allow.
(3) Once the loan has disbursed from investors to entrepreneurs' real account the agent bank (CABS-AT) which doesn't hold disbursed loan as an asset in its balance sheet administers the loan transaction on off balance sheet by creating investor's disbursement loan ledger integrated real account with entrepreneur's loan ledger integrated real account on off balance sheet where investor's fund invested on entrepreneur/borrower project.
(4) Up on disbursement of loan from investor to entrepreneur the system enable to access the debit amount of investor's loan ledger integrated with the entrepreneur's loan ledger on off balance sheet to calculate on the remaining loan balance either loan interest rate, which can be set based on either the market or the Agent bank (CABS-AT), or profit rate, which can be calculated based on the market or by the agent bank (CABS-AT) having considered entrepreneur/borrower's profit before tax, or loan cost rate, which can be calculated by the agent bank (CABS-AT) based on loan administrative intensity which increases according to the size of loan, or trade price rate, which can be spot or future spot or forward by which the loan settlement is once after effecting payment to goods suppliers, on daily bases, said The interest rate or profit rate or loan cost rate or trade price rate calculated on investor's remaining disbursement balance and entrepreneur's principal loan balance set on separate column without capitalizing on the principal loan balance.
(5) Commission agent banking system (CABS-AT) calculates interest rate or profit rate or loan cost rate or trade price rate on the remaining balance of investor and entrepreneur/borrower's loan ledgers, wherein entrepreneurs/borrowers pay loan repayments to investors the portion of principal loan repayment credits the investor's loan leger balance and the loan repayment, which contain portion of principal loan repayment and interest rate or profit rate or loan cost rate or trade price rate, first clear the entrepreneur/borrower loan ledger's loan price and by excess above the loan price the loan repayment pays the principal loan balance and on the remaining balance interest rate or profit rate or loan cost rate or trade price rate calculates on daily bases and the agent bank (CABS-AT) collects ahead commission on interest rate or profit rate or loan cost rate or trade price rate into balance sheet income account, that will be calculated for investors, on daily bases.
(B) a component for collecting portion of principal loan repayment that can credit the investor principal disbursement balance on off balance sheet while loan repayment effected by entrepreneur/borrower can be calculated by the following steps
Step.1: The portion of loan repayment by entrepreneur without interest rate or profit rate or loan cost rate or trade price that linked with single investor's investment can be calculated as follow
$$Re payment without loan price = \frac{loan disbursed to entrepnuer}{Number of repayments}$$
Step.2: Share of investor's loan repayment collected from entrepreneur can be calculated as follow
$$Investor ’ s share on total principal loan = \frac{investor ’ s fund on project}{investor ’ s related project ’ s total principal loan}$$
Step. 3: the portion of principal loan repayment from entrepreneur that will be credited on balance of investor's ledger can be calculated as follow
$$Re payment proportion = ( repayment without loan price ) \times ( investor ’ \text{} s share on total principal loan )$$
For non-revolving lending strategy portion of loan repayment of the investor having interest rate or profit rate or loan cost rate or trade price rate can be calculated by the above same steps considering loan price on the disbursed principal loan to credit periodically into investors' real accounts;
(C) a component for calculating investors' reinvestment amount according to their seniority can be calculated as
$$Re payment reinvestment amount = \frac{b}{T} \times cr \times {s}_{t}$$
Where:
T=Total investment period by CABS
b=number of investor's stayed years in investment at this bank
cr=portion of principal loan repayments collected from all investor's related projects
Sₜ=Total share of investment at given time(t)
$$Total investment share at given time ( {S}_{t} ) = \frac{Total disbursed amount on all projects}{Total investors funds balance}$$
Repayment reinvestment amount not allowed to be greater than total investor's invested amounts and total loan price excess above the agent bank (CABS-AT)'s commission calculated since this is maximum reinvestment limit by which the agent bank (CABS-AT) reinvest the repayment collected priorly for senior investors, said interest or profit rate or loan cost rate or trade price rate included reinvestment can be calculated considering interest rate or profit rate or loan cost rate or trade price rate bearing repayments collected for which the interest rate or profit rate or loan cost rate or trade price rate calculated on investor fund disbursement ledger capitalized on the principal fund disbursement ledger without crediting investors' accounts per agreement with agent bank (CABS-AT);
(D) a component for investing in multiple projects by investor with different loan terms under different loan interest rate or profit rate or loan cost rate or trade price is possible using commission agent banking system (CABS-AT) which handles the loan transaction on off balance sheet by opening different investor's fund disbursement ledger under each loan interest or profit rate or loan cost rate or trade price rate categories interconnecting the investor's investment under the same interest rate or profit rate or loan cost rate or trade price with entrepreneur's project where the investor invested money;
(E) a component for collecting portion of principal loan collected Per agreement between investor and agent bank (CABS-AT) for investor reinvested on another entrepreneur's project through agent bank (CABS-AT) and the invested equivalent amount added up on the investor's principal fund ledger balance and up on which the agent bank calculates interest rate or profit rate or loan cost rate or trade price rate and the calculated loan price added up on separate column of the ledger without capitalizing on the remaining investor's principal fund balance and the agent bank (CABS-AT) collects commission into its balance sheet income account on interest rate or profit rate or loan cost rate or trade price rate that will be given to investor per loan repayment effected by entrepreneurs/borrowers, Said up on agreement between the investor and the agent bank (CABS-AT) the loan interest rate or profit rate or loan cost rate or trade price rate calculated as excess above the agent bank (CABS-AT) commission can be reinvested on multiple entrepreneurs/borrowers' projects, otherwise the loan price excess above the agent bank (CABS-AT)'s commission on the interest rate or profit rate or loan cost rate or trade price calculated will be credited into investors' real accounts on daily bases or periodically, said this approach enable the investors to invest in multiple projects while priorly invested projects by investors settled their loans on their maturity dates and under non-revolving lending strategy the repayments excess above the agent bank commission credited into investors' real accounts periodically;
(f) a component for disbursing investors' fund by Commission agent banking system (CABS-AT) to entrepreneurs without holding the disbursed loan on its balance sheet to transfer credit and liquidity risks of the bank adopted the agent bank (CABS-AT) and in turn manage risks of investors and entrepreneurs applying investors and entrepreneurs' substitution strategies without transferring loan originated borrowers' pledged properties to third parties unless the disbursed loan unable to be recouped and by making entrepreneurs/borrowers engaged with loan default insurance coverage for which insurance premium can be paid by entrepreneurs/borrowers according to their business cash inflow fluctuation so as to have mutual benefit among investors, entrepreneurs and the agent bank (CABS-AT) itself;
(G) a component for calculating trade Price benefit of investors in trade transaction which can be calculated based on their seniority as follow
$$Transaction income per seniority of investor = \frac{IPt}{r} {s}_{t}$$
CABS−AT(Agent bank's) commission=(agreed commission rate)(Pₜ)(total invested amount)
Where:
I=Investor's invested amount
P=Trade price, which can be spot, future spot or forward rate less commission
t=total time of investor's investment u sin g CABS-AT
Sₜ=Total share of investment at given time(t)
$$Total investment share at given time ( {S}_{t} ) = \frac{Total disbursed amount on all projects}{Total investors funds balance}$$
r=total periods of Investors' investment in CABS-AT
Pₜ=total price for investment amount in given time
(H) a component for calculating loan cost rate based on loan administration intensity which can increase according to the size of loan disbursed from investor to entrepreneur/borrower through the agent bank (CABS-AT) can be calculated as follow
$$loan cost rate ( LCR ) = \frac{\begin{matrix}( commission rate + 1 ) \\ ( loan adminitrative expense with profit markup )\end{matrix}}{( principal loan )}$$
Loan administrative expense budget is to calculate by the agent bank (CABS-AT) ahead of disbursement of the given loan;
(I) a component for calculating agent bank (CABS-AT) commission based on commission rate and investors loan price which can be calculated as follow
Agent bank (CABS-AT) commission=commission rate(loan interest rate or loan cost rate or profit rate or trade price rate)
Investors' loan price=((loan interest arte or loan cost rate or profit rate or trade price rate)−Agent bank (CABS-AT)′ commission)(1−income tax)

16. The system of claim 15, wherein Commission agent banking system (CABS-AT) pools local money from investors' accounts with support of financial application or computer product for purpose of international money transfer to benefit the recipients in the country in local currency so as to benefit investors foreign currency which later enable them to invest in international investment to get loan interest rate or loan cost rate or profit rate or trade price rate after the agent bank (CABS-AT) has collected commission thereon into its balance sheet income account.

17. A program product for Commission agent banking system (CABS-AT) administers loans of banks through recommendation having established agreement with banks without removing the assets from banks' balance sheet but based on the profile of the loans applying borrowers by entrepreneurs substitution strategies without ownership transfer and enabling the new entrant entrepreneur work with the withdrawing borrower's full-fledge business to manage credit and liquidity risks of banks which enable to collect sustainable loan repayments to banks and collecting commission on interest rate or profit rate or loan cost rate or trade price rate from that can be given to banks, wherein the depositors of the banks where their money deposited can also shift to investors' position to get credit price instead of deposit interest or divided by taking loan share on the bank already invested project, said the banks which have affiliation with depositors that wish to move to investors position relief from liquidity and credit risks and the bank adopted commission agent banking system (CAB-AT) can benefit from commission collected on interest rate or profit rate or loan cost rate or trade price rate through the agent bank (CABS-AT) and enable to transfer its liquidity and credit risks to investors and entrepreneurs/borrowers, comprising:
One or more computer and selected mobile banking readable media having computer and mobile banking readable program codes if loan transaction carried out by a computer and mobile banking, the computer and mobile banking readable program code comprising:
A program code for accessing one or many databases comprising:
(A) Program code for accessing one or more electronic databases
(1) a loan pooled by the agent bank (CABS-AT) from banks to administer using information of the debtors of the banks without removing the asset from banks' balance sheets.
(2) The banks' loan ledger accounts opened by the agent bank (CABS-AT) on off balance sheet having the bank's unique identification code, comprising:
(i) a respective loan transaction loan ledger account integrated with real account of the bank and respective borrowers;
(ii) loan transaction data for respective bank's and the agent bank (CABS-AT) balance sheet accounts;
(iii) loan repayment and the agent bank (CABS-AT) commission calculated effected into the respective balance sheet account of the bank and the agent bank (CABS-AT) respectively.
(3) information on the respective amount of loan pooled from bank held in off balance sheet loan ledger integrated with control operating account at agent bank (CABS-AT) for each of borrowers' loan transaction account;
(B) program code for obtaining loan transaction data of bank's borrower from plurality of loan transaction said the bank loan transaction account integrated with pooled loan ledger on off balance sheet, said loan repayments collection from one or more loan originated bank's loan borrowers' accounts and transfer of loan repayments excess above the agent bank (CABS-AT)'s commission into real account of the bank maintained at agent bank and transfer of the agent bank (CABS-AT) commission into the agent bank balance sheet income account.
(C) program code for obtaining aggregated loan repayments transaction from plurality of loan originated banks' borrowers;
(D) program code for authorizing receipt of loan repayments collected from plurality of loan originated banks' borrowers accounts into the agent bank (CABS-AT) central account and from which loan repayments excess above the agent bank (CABS-AT) commission transfer into the loan originated banks' accounts, where the loan pooled, said transferring loan repayments maintained at agent bank (CABS-AT) in name of the loan originated banks into the banks' balance sheet accounts to effect loan repayments on real loan account of the borrowers' loan ledger as well as loan balance sheet accounts of the loan originated banks;
(E) program code for determining at least one or more pooled loans from plurality of banks and if the loan status determined as the borrowers deemed failing to pay loan repayments to loan originated bank, apply one or more borrowers' substitution strategy of the agent bank (CABS-AT) by one or more entrepreneurs that rent full-fledged working business or properties of the withdrawing borrowers with own capital getting benefit from the business profit excess above the repayment set by the agent bank (CABS-AT) without transferring property ownership to maintain loan repayments sustainability and settle loan balance within the agreed loan period; (F) program code for changing or having changed loan repayments attribution because of borrowers' substitution strategies in the one or more electronic databases in one or more distinct borrowers' loan repayment accounts that connected with the agent bank (CABS-AT) control operating or central account to administer the loan repayments while the loan repayments accounts sources changed through each loan periods due to investors and entrepreneurs/borrowers substitution strategies;
(G) Program code for transferring loan repayments excess above the agent bank (CABS-AT) commission on loan price from aggregated loan accounts of loan originated banks maintained at the agent banks to plurality of banks' balance sheet accounts maintained at loan originated banks;
(H) Program code for generating instructions to have transferred loan repayments, which excess above the agent bank (CABS-AT) commission collected from plurality of entrepreneurs/borrowers accounts, from banks' accounts maintained at the agent bank (CABS-AT) into plurality of loan originated banks' balance sheet accounts;
(I) Program code for generating report, communicating and managing risks for each loan transaction with industry expert analysis to notify each loan status to the parties involved in loan transaction.
(J) program code for allowing money depositors of bank whose loans pooled administer under agent bank (CABS-AT) to buy loan share, which can be removed as portion of sold loan share from balance sheet of loan originated banks, on the projects of entrepreneurs/borrowers which can be administered under agent bank (CABS-AT) based on profile of debtors to collect loan interest rate or loan cost rate or profit rate or trade price rate which calculates on principal loan share amount of investors/depositors maintained on off balance sheet loan ledgers integrated with the borrowers project loan ledger on off balance sheet after the agent bank (CABS-AT) has collected its commission on loan interest rate or loan cost rate or profit rate or trade price rate calculated on portion loan share while portion of repayments effected from plurality of entrepreneurs/borrowers accounts into investors/depositors accounts.

18. A program product for Commission agent banking system (CABS-AT) by which it can pool loans backed by assets from banks and issue securities or contractual agreements to investors based on investment risk level by paying total outstanding loan balance by investors' fund to remove the assets from banks' balance sheet using investors and borrowers/Entrepreneurs' substitution strategies without property's ownership transfer to the next entrepreneurs, wherein the borrowers, that failed in repaying loan, full-fledge business rented to new entrant entrepreneurs to maintain the loan repayments sustainability considering excess above the loan repayment as profit of new entrant entrepreneurs since entrepreneurs get into this business using their own fund and the asset held as collateral backs to property owner unless otherwise loan unable to be collected for which the property will be sold to public to collect the disbursed loan, Wherein investor fail to continue the loan transaction the agent bank (CABS-AT) sells the remaining uncollected principal loan to new entrant investor for which new security in name of investor issue or engage in contractual agreement by agent bank (CABS-AT), wherein till loan settlement the agent bank (CABS-AT) collects commission on interest rate or profit rate or loan cost rate or trade price rate that has given to investors, wherein loan repayments from borrowers can be reinvested to pool another loans backed by assets from banks and the principal loan repayments collected from investors' investment linked with project's business credits into investors off balance sheet principal fund ledger to calculate interest rate or profit rate or loan cost rate or trade price rate on remaining balance which will be available after repayment relative to portion of fund invested credited and decrease the balance, wherein reinvestment of repayment collected on behalf of the investor capitalize on investor's disbursement ledger according to seniority of investors and the interest rate or profit rate or loan cost rate or trade price rate calculates on daily bases and accrues on separate column of the ledger without capitalizing on principal fund disbursed by agent bank (CABS-AT) on behalf of the investor, said Per agreement between the investor and agent bank (CABS-AT) the loan price daily will be credited into investors' accounts or reinvested by capitalizing on the remaining disbursed fund and the agent bank (CABS-AT) collects commission on interest rate or profit rate or loan cost rate or trade price rate that has been calculated on principal loan to investors, Comprising:
one or more computers and selected mobile banking readable medias having computer and mobile banking readable program codes if loan transaction carried out by a computer and mobile banking, the computer and mobile banking readable program code comprising:
A program code for accessing one or many databases comprising:
(A) Program code for accessing one or more electronic databases
(1) a loan pooled by the agent bank (CABS-AT) from banks to administer on behalf of investors by settling or removing the asset from balance sheet of banks by the investors' collected funds.
(2) off balance sheet loan ledgers account opened by the agent bank (CABS-AT) for investors and borrowers involved on same projects having loan transaction unique identification comprising:
(i) a respective loan transaction loan ledger account integrated with real account of each investors and borrowers
(ii) loan transaction data for respective investors and borrowers' and the agent bank (CABS-AT) balance sheet accounts
(iii) loan repayment and the agent bank (CABS-AT) commission calculated effected into the respective balance sheet account of investors and the agent bank (CABS-AT) respectively.
(3) Information on the respective amount of loan pooled from banks held in off balance sheet loan ledgers integrated with control operating account at agent bank (CABS-AT) in name of each investors and borrowers integrated with their respective real accounts.
(B) program code for obtaining loan transaction data of investors and borrowers from plurality of loan transactions said the investors and entrepreneurs/borrowers loan transaction accounts integrated with respective pooled loan ledgers on off balance sheet, said loan repayments collection from one or more borrowers' accounts transfers excess above the agent bank (CABS-AT) commission, which calculated on loan interest rate or loan cost rate or profit rate or trade price rate into the agent bank (CABS-AT) balance sheet income account, into real accounts of investors maintained at agent bank (CABS-AT);
(C) program code for obtaining aggregated loan repayments transactions from plurality of borrowers' accounts that could be transferred into investors accounts after the agent bank (CABS-AT) has collected commission on loan interest rate or loan cost rate or profit rate or trade price rate which calculated on the remaining loan balance;
(D) program code for authorizing receipt of loan repayments collected from plurality of borrowers accounts into the agent bank (CABS-AT) central account and from which loan repayments excess above the agent bank (CABS-AT) commission transferred into borrowers' project integrated investors' accounts, said transferring the agent bank (CABS-AT) commission on each and every loan transaction's loan price such as loan interest rate or loan cost rate or profit rate or trade price rate into balance sheet income account when payments effected into plurality of investors' accounts from plurality of borrowers' accounts;
(E) program code for determining at least one or more pooled loans from plurality of banks and if the loan status determined as the borrowers deemed failing to pay loan repayments to respective investors, apply borrower's substituting strategy of the agent bank (CABS-AT) by entrepreneurs that rent full-fledged working business or properties of the withdrawing borrowers with own working capital to get business's profit excess above the loan repayment set by the agent bank (CABS-AT) without transferring property ownership to third party to maintain loan repayments sustainability and settle loan balance within the agreed loan period and if investor fail to continue the loan transaction apply investor's substitution strategy of the agent bank (CABS-AT) by new entrant investor that settle the withdrawing investors' principal uncollected remaining loan balance;
(F) program code for changing or having changed loan repayments attribution because of investors and borrowers' substitution strategies of the agent bank (CABS-AT) in the one or more electronic databases and in one or more distinct investors and borrowers' loan repayment accounts that connected with the agent bank (CABS-AT) control operating or central account to administer the loan repayments while the loan repayments accounts sources and recipient changed through each respective loan periods;
(G) program code for transferring loan repayment excess above the agent bank (CABS-AT) commission on loan price, such as loan interest rate or loan cost rate or profit rate or trade price rate, from aggregated loan ledger accounts of respective investors maintained at the agent banks to plurality of investors' real accounts;
(H) Program code for generating instructions to have accessed investors' fund accounts for disbursement to plurality of entrepreneurs/borrowers' business projects and transferred loan repayments from plurality of borrows' accounts by the agent bank (CABS-AT) into plurality of investors accounts after the agent bank (CABS-AT) collected its commission on loan interest rate or loan cost rate or profit rate or trade price rate into its balance sheet income account;
(I) program code for reinvestment of repayments that pooled from plurality of borrowers' accounts into investors' accounts per the agreement established between investors and the agent bank (CABS-AT), said the reinvestment of portion of principal loan repayments and loan price in multiple projects continue according to seniority of investors' investment under the agent bank (CABS-AT) administration applying investors and entrepreneurs/borrowers' substitution strategies, said the program code enable to determine seniority of investors' investment to run the repayments reinvestment by the agent bank (CABS-AT) seemingly;
(J) Program code for generating report, communicating and managing risks for each loan transaction with industry expert analysis to notify each loan status to the parties involved in loan transaction.

19. Program product for Commission agent banking system (CABS-AT) runs international or local loan transaction where the investors and entrepreneurs/borrowers can be found in separate or within country which gave permission with government guarantee to agent bank (CABS-AT) to handle loan transaction using central foreign currency account of agent bank (CABS-AT) established at these countries or at correspondent bank to pool fund from investors and invest in entrepreneurs/borrowers' projects which is found at corresponding country or within country applying investor and entrepreneur's substitution strategies, wherein Interest rate or profit rate or loan cost rate or trade price rate can be established under international market and as per the agreement between investors and agent bank (CABS-AT) the repayments collected from entrepreneurs/borrowers can be transferred into corresponding countries investors' accounts or can be reinvested on another international entrepreneurs/borrowers' projects, wherein the agent bank handles the investors and entrepreneurs' loan ledgers separately on its off balance sheet calculating interest rate or profit rate or loan cost rate or trade price rate on remaining loan balance after portion of principal loan repayment credited into investor's fund disbursement balance on off balance sheet ledger or the full repayment clear first portion of the loan interest rate or profit rate or loan cost rate or trade price rate after the agent bank (CABS-AT) has collected its commission thereon and by excess above which clears portion of principal loan balance of the entrepreneurs/borrowers on off balance sheet ledger, said The loan transaction can be run by the two or more corresponding countries where investors and entrepreneurs/borrowers available intermediating the loan transaction with common international currency and the agent bank hedges risks related with foreign currency maintaining in this account by more stable currency and modern or traditional methods, comprising:
one or more computers and selected mobile banking readable medias having computer and mobile banking readable program codes if loan transaction carried out by a computer and mobile banking, the computer and mobile banking readable program code comprising:
A program code for accessing one or many databases comprising:
(A) Program code for accessing one or more electronic databases
(1) preliminary loan transaction qualifiable screening of investors and entrepreneur/borrowers or loan transaction applicants based on information supplied by applicants at account creation using the program product connected with the agent bank (CABS-AT)'s server or remote server, said the acceptance or rejection to proceed the loan transaction be acknowledged by the agent bank (CABS-AT) through electronic mail to the applicants and the acceptance letter that acknowledge the applicants to proceed the loan transaction, comprising:
I. Real account opening by investors and entrepreneur/borrowers at agent bank (CABS-AT);
II. Selection of the best fitted investment project of one or more entrepreneurs/borrowers or investors' fund available with respective loan interest rate or loan cost rate or profit rate or trade price rate with respective loan terms;
III. Establishing tri-party agreement among investors, entrepreneurs and the agent bank (CABS-AT) itself involved in one to many or many to one or many to many or one to one loan transactions;
IV. Selection of an application to integrate real account with off balance sheet ledgers opened in name of investor and entrepreneur/borrower and integrated with respective entrepreneur/borrower project;
V. Options for investors to pool fund and place into their real accounts maintained at agent bank (CABS-AT);
VI. Option for investor to select revolving lending, where repayments collected from entrepreneurs/borrowers to be reinvested on different projects according to investment seniority of investors, and non-revolving lending, where repayments reinvestment is not allowed but periodically crediting into investors' real accounts;
VII. Options to accept the agent bank (CABS-AT)'s commission rate that will be calculated on the investors' loan interest rate or loan cost rate or profit rate or trade price;
VIII. Option to accept investors or entrepreneurs/borrowers' substation strategies of agent bank (CABS-AT);
IX. Option to get investment consultation and risk mitigation for investor and entrepreneur/borrower from the agent bank (CABS-AT);
X. Option to invest in one or more entrepreneurs/borrowers projects with different loan interest rate or profit rate or loan cost rate or trade price;
XI. Option to know the loan status and risk mitigation mechanisms applied by the agent bank (CABS-AT);
XII. Option to know investor's investment seniority and reinvestment amount held by the agent bank (CABS-AT);
XIII. Option to run loan transaction in different digital and non-digital currencies;
XIV. Option to select loan interest rate or loan cost rate or profit rate or trade price rate that calculates on remaining investors and entrepreneur/borrower loan ledger balance;
(2) A fund pooled by the agent bank (CABS-AT) from international investors and financed on international entrepreneurs/borrowers projects where the investors and entrepreneurs/borrowers found at different countries in common selected currency;
(3) off balance sheet loan ledgers accounts opened by the agent bank (CABS-AT) for investors and borrowers having the agent bank's(CABS-AT) unique identification comprising;
(i) a respective loan transaction on off balance sheet loan ledgers accounts integrated with the respective real accounts of each investors and borrowers to disburse and recoup the loan through the respective accounts;
(ii) loan transaction data for respective investors and borrowers' and the agent bank (CABS-AT) on and off balance sheet accounts;
(iii) loan repayment and the agent bank (CABS-AT) commission on loan price calculated effected into the respective balance sheet account of investors and the agent bank (CABS-AT) respectively said the loan repayment is under revolving or non-revolving lending strategy;
(4) information on the respective amount of loan pooled from investors' accounts held in off balance sheet loan ledger integrated with control operating account at agent bank (CABS-AT) for each of investors and borrowers' loan transaction;
(5) Periodical report with industry expert level analysis on loan transaction and status to parties involved in respective loan transaction, such as investors, entrepreneurs/borrowers and the agent bank (CABS-AT) itself, said the agent bank (CABS-AT) access periodic financial statements with industry level analysis for reporting purpose;
(B) program code for obtaining loan transaction data of investors and entrepreneurs/borrowers from plurality of loan transactions said the investors' loan transaction account integrated with pooled loan ledgers on off balance sheet, said loan repayments collection from one or more plurality of borrowers' accounts and transfer loan repayments excess above the agent bank (CABS-AT)'s commission into real accounts of investors maintained at agent bank (CABS-AT) and transfer the agent bank (CABS-AT)'s commission on loan interest rate or loan cost rate or profit rate or trade price rate into the agent bank (CABS-AT) balance sheet income account;
(C) program code for obtaining aggregated loan repayments transactions from plurality of borrowers' accounts that could be transferred into respective investors' accounts after the agent bank (CABS-AT) collected commission on loan interest rate or loan cost rate or profit rate or trade price rate which calculated on the remaining loan balance to benefit investors;
(D) program code for authorizing receipt of loan repayments collected from plurality of borrowers accounts into the agent bank (CABS-AT) central account or operating control account and from which loan repayments excess above the agent bank (CABS-AT) commission transferred into borrowers' project integrated investors' accounts, said transferring the agent bank (CABS-AT) commission on each and every loan transaction's loan price such as loan interest rate or loan cost rate or profit rate or trade price rate into its balance sheet account when payment effected into investors' accounts from plurality of borrowers' accounts;
(E) program code for determining at least one or more pooled funds from plurality of investors accounts and if the loan status determined as the borrowers deemed failing to pay loan repayments to respective investors' accounts, apply investor and borrower's substituting strategy of the agent bank (CABS-AT) by new entrant investor that refunds the remaining principal unpaid loan balance to the withdrawing investor and entrepreneur that rent full-fledged working business or properties of the withdrawing borrowers without transferring property ownership to third party to maintain loan repayments sustainability unless no alternative solution found to recoup the disbursed loan and settle loan balance within the agreed loan period having kept international loan transaction protocol;
(F) program code for changing or having changed loan repayments attribution because of investors and borrowers substitution strategies in the one or more electronic databases in one or more distinct investors and borrowers' loan repayments accounts that connected with the agent bank (CABS-AT) control operating or central account to administer the loan repayments while the loan repayments accounts sources and recipient changed through each respective loan periods;
(G) program code for transferring loan repayments excess above the agent bank (CABS-AT) commission on loan price, such as loan interest rate or loan cost rate or profit rate or trade price rate, from aggregated loan ledger accounts of respective investors' off balance sheet loan ledger accounts maintained at the agent bank (CABS-AT) to plurality of respective investors' real accounts;
(H) Program code for generating instructions to have disbursed loans to plurality of entrepreneurs/borrowers' accounts and managed loan repayments from plurality of entrepreneurs/borrowers' accounts by the agent bank (CABS-AT) into plurality of investors accounts having collected the agent bank (CABS-AT) commission on loan interest rate or loan cost rate or profit rate or trade price rate into its balance sheet income account;
(I) program code for reinvestment of repayments that pooled from plurality of entrepreneurs/borrowers' accounts into investors accounts per the agreement established between investors and the agent bank (CABS-AT), said the reinvestment of portion of principal loan repayment and loan price in multiple projects continue according to seniority of invests' investment under the agent bank (CABS-AT) administration applying investors and entrepreneurs/borrowers' substitution strategies, said the program code enable to determine seniority of investors' investment to run the repayments reinvestment by the agent bank (CABS-AT) seemingly;
(J) Program code for investors or entrepreneurs' substitution strategy to manage risks of the parties involved in loan transaction and to recoup the loan repayments properly, Wherein investor fail to continue either in international or local loan transaction the remaining principal loan balance will be sold by agent bank (CABS-AT) to new entrant investors that finance the remaining uncollected loan balance to the withdrawing investors, wherein entrepreneurs fail to pay the loan the entrepreneurs substitute by new entrant entrepreneurs with own capital without property ownership transfer to another party or entrepreneur unless otherwise loan could not be recouped said the liquidity and credit risk felt on the collateral pledged or default loan insurance coverage engaged by entrepreneur and business income excess above the loan repayments considers as profit of the new entrant entrepreneurs;
(K) Program code for full-fledge agent bank (CABS-AT) to access incubating investors and entrepreneurs for its investors and entrepreneurs substitution strategies when the existing investors or entrepreneurs fail to continue loan transaction, said the agent bank (CABS-AT) cannot pay deposit interest rate or dividend for those money depositors, such as investors and entrepreneurs, at this bank till the money deposited reaches loanable fund which later can be invested either on new entrepreneurs/borrowers' projects or existing entrepreneurs' projects when existing investors request the agent bank (CABS-AT) to withdraw from loan transaction and substitute incubated entrepreneur with own fund deposited at agent bank (CABS-AT) when existing entrepreneurs/borrowers deemed failing to pay loan of investors to collect business profit using withdrawing borrowers' property excess above the repayment set for the loan;
(L) Program code for generating report, communicating and managing risks for each loan transaction with industry expert analysis to notify each loan status to the parties involved in loan transaction.

20. The Program product of claim 19, wherein program code calculates plurality of loan interest rate or profit rate or loan cost rate or trade price rate that can be calculated on disbursed loans and credits respective investors' plurality accounts or reinvest in another entrepreneurs/borrowers' projects along with portion of principal loan repayments and the commission, which can be set having considered the market rate and the agent bank (CABS-AT)'s loan administrative expense while administrating the loan after disbursement, on plurality interest rate or profit rate or loan cost rate or trade price rate and onetime project selection fee per project credit into agent bank (CABS-AT)'s balance sheet income account.

21. The Program product of claim 19, wherein loan interest rate or profit rate or loan cost rate or trade price rate fluctuation the commission agent bank (CABS-AT) make investors and entrepreneurs/Borrowers to use interest rate or profit rate or loan cost rate or trade price rate swap in order to manage risk related with interest rate or profit rate or loan cost rate or trade price rate, said the transaction on behalf of the investors handles by the agent bank (CABS-AT).

22. The program product of claim 19, wherein commission agent banking system (CABS-AT)'s efficiency can be measured as commission and fee incomes against total expense which is recommended to be greater than 1:1 and less than or equal to this ratio indicates expense overrun which needs management attention.

23. The program product of claim 19, wherein Commission agent banking system (CABS-AT) sets loan repayment which can be considered as business rent price for new entrant entrepreneur based on ratio of total entrepreneur/borrower's outstanding loan to collateral or the value of full pledge business, said If the ratio is above 1:1 the current loan repayment increases than the previous, said If the ratio is below 1:1 the previous loan repayment considered for new entrant entrepreneur's repayment and always the excess above the loan repayment considered as profit of new entrant entrepreneur.

24. The program product of claim 19, wherein Commission agent banking system (CABS-AT) pools money from investors to invest on depositors' overdrawn balance to benefit investors loan interest rate or profit rate or loan cost rate or trade price rate after the agent bank (CABS-AT) has collected commission thereon establishing agreement on limit of overdrawing deposit balance and loan administration among the investors, depositors and the agent bank (CABS-AT) itself having applied revolving or non-revolving lending strategy, said this can be done by linking plurality of deposit borrowers' loan ledgers with plurality of investors' fund disbursement ledgers so as to handle the loan repayments and loan interest rate or profit rate or loan cost rate or trade price rate calculation on the remaining balance of loans, said the excess above agent bank (CABS-AT)'s commission on plurality of loan interest rate or profit rate or loan cost rate or trade price rate credits into plurality of investors' accounts or reinvest along with the portion of principal loan repayments according to investment seniority of investors.

25. The program product of claim 19, wherein entrepreneur's project selection can be carried out either by investors or agent bank (CABS-AT), said Project selection by agent bank (CABS-AT) charges investors' onetime fee as cost of project selection that will be collected from plurality of real accounts of investors.

26. The program product of claim 19, wherein Commission agent banking system (CABS-AT) considers a loan as non-performing when an entrepreneur's or borrower's business profit strongly decelerates and become at equilibrium stage where business's revenue and expense equal or up on failures of one loan repayment unless an entrepreneur/borrower has priorly engaged with insurance to cover the defaulted loan amount, said the defaulted single loan repayment can be recouped from new entrant entrepreneur that substitutes the principal borrower one.

27. The program product of claim 19, wherein Commission agent banking system (CABS-AT) renders consulting service based on forecasted risks of entrepreneur/borrower's business/project and the service price of which can be consider in its commission rate.

28. The program product of claim 19, wherein Commission agent banking system (CABS-AT) calculates onetime fee from withdrawing one or more investors' accounts as penalty assuming the fee as the cost of searching substituting investors.

29. The program product of claim 19, wherein Commission agent banking system (CABS-AT) pools money from international investors to lend money for importer through importers' bank, which can establish loan agreement with the agent bank (CABS-AT), which later lend the importer in local currency and to lend money for exporters at corresponding countries having established agreement with exporters' banks so as to benefit investors profit rate or interest rate or loan cost rate or trade price rate calculated on loans after the agent bank (CABS-AT) has collected its commission thereon, said this enable the importers and exporters banks' to lend the importers and exporters in their respective local currency and pay the debt in foreign currency to the agent bank (CABS-AT).
REFERENCE
1. Wikipedia contributors. (2023, November 8). Interest Rate Commission Agent Banking System. In Wikipedia, The Free Encyclopedia. Retrieved 22:27, Jan. 1, 2024, from https://en.wikipedia.org/w/index.php?title=Interest_Rate_Commission_Agent_Banking_System &oldid=1184178163
